(19) United States
(12) Patent Application Publication
(10) Pub. No.: US 2020/0394603 A1
(43) Pub. Date: Dec. 17, 2020

(54) Device and Method for Preparing Ingredients for at Least One Dish

(71) Applicant: Marley Spoon AG, Berlin (DE)

(72) Inventors: Mathias Ottitsch, Ismaning (DE); Michal Rychard, Olesnica (PL); Anton Daigeler, Brooklyn, NY (US); Ralph Siegel, Kempen (DE)

(21) Appl. No.: 16/968,389

(22) PCT Filed: Feb. 8, 2019
(86) PCT No.: PCT/EP2019/053179

§ 371 Date: Aug. 7, 2020

(30) Foreign Application Priority Data
Feb. 9, 2018 (DE) 10 2018 103 006.1
Dec. 6, 2018 (DE) 10 2018 131 154.0

(51) Int. Cl. G06Q 10/08; G06Q 30/06; G06Q 50/12; G06Q 10/06; G06Q 30/00; B65G 47/08; B65G 47/90; B65B 57/00; B65B 43/52; B65B 25/22

(52) U.S. Cl. CPC G06Q 10/0832; B65G 2203/0216; G06Q 50/12; G06Q 10/0875; G06Q 10/06395; G06Q 10/06312; G06Q 30/0185; B65G 47/08; B65G 47/905; B65B 57/00; B65B 43/52; B65B 25/22; G05B 2219/45054; B65G 2203/044; G06Q 30/0635

(57) ABSTRACT

According to the invention, a method is provided for preparing, in particular for assembling and packaging, ingredients for at least one dish. This method comprises the following steps:
a reading step in which a customer's order data are read, this order data comprising at least recipe data for the ingredients contained in the dish as well as customer data,
an assigning step in which at least one ingredient container is assigned predefined customer data,
a conveying step in which the ingredient container is conveyed to a transport device of a packaging line,
a positioning step in which at least one ingredient container is positioned in the region of a loading station of the packaging line by means of the transport device, this loading station having at least two ingredients or three, four, or more ingredients kept on hand in corresponding ingredient compartments,
an indicating step in which corresponding indicators of the ingredient container and ingredient compartments indicate whether they are included in the recipe data,
a loading step in which, if the ingredients are included in the recipe data, the ingredient container is loaded with the corresponding ingredient or ingredients in the loading station,
the repetition and execution of the positioning step, the indicating step, and the loading step until all of the ingredients included in the recipe data have been placed in the ingredient container.

The present invention relates to a device and a method for preparing ingredients for at least one dish.

US 2007/0150375 A1 discloses a method and a device for efficient meal delivery. In this case, customers can order a meal online, e.g. from a restaurant. The order is forwarded to a corresponding restaurant by means of a server. With this system, the restaurants deliver the meal to a mobile pickup location; the mobile pickup location is then stationed for a determined time period in the vicinity of a plurality of customers so that they can pick up their meals.

EP 2 525 309 A1 discloses a stationary or mobile station for providing consumer goods, in particular fresh and frozen foods. In this case, an in particular local collection station is provided, which is designed for storing ordered goods baskets and outputting a particular goods basket to a correspondingly identified customer. The goods are provided in a central picking station by means of a largely automated logistics system, which assembles goods baskets from individual product units for end consumers. In this case, this picking system accesses a central warehouse and withdraws the ordered goods.

DE 10 2013 225 476 A1 provides a method and a system for improving an intelligent goods management.

DE 20 2014 008 283 U1 discloses an automated, as-needed preparation and output system for foods. In this case, a customer can use a data entry program to have an individual food output packet assembled as needed by a computer and output by means of a food vending machine.

DE 20 2015 103 841 U1 discloses a warehouse for handling and/or distributing goods. In this case, the goods stored on shelving units are withdrawn, for example by means of a warehouse robot, according to a customer order and are then conveyed to a distribution point to be delivered to a customer.

DE 697 23 007 T2 discloses a method and a device for providing meals and/or meal components. This involves storing basic products, pretreating them, which for example means that they are vacuum packed, vacuum cooked, and then the cooked products are stored. In addition, temporary refrigerating procedures can be carried out.

WO 2009/120262 A1 discloses a system for preparing and packaging foods. In this case, based on an order, e.g. in restaurant that is using the system, a container is supplied to a conveyor belt and foods are inserted into it at successive stations. Corresponding interim steps in the food preparation can be outsourced in order to increase the efficiency.

EP 1 844 663 A1 discloses a method for preparing fresh foods.

DE 10 2008 056 541 A1 discloses a method and a system for creating a menu of dishes. In this case, ingredients that have not yet been cooked are pre-portioned and, if need be, pre-cut in accordance with a user's selection. These are then individually packaged and are then delivered by the customer in a not yet prepared, i.e. not yet precooked or par-roasted state. This permits the customer to independently prepare a fresh menu of dishes without having to go shopping for this or having to portion and/or chop the ingredients. In this case, the order is placed using a corresponding menu selected to the customer. In addition, raw ingredients are portioned based on an end-user's selection, with the measuring being carried out according to the number of people who will be eating a meal.

“Paperless” picking methods such as pick by light systems (known in German as “Kommissionieren nach Licht”) are also known. Instead of a picking list or pick list, the articles and quantities to be picked are sent to the picker by a light indicator provided directly on the storage compartment. “Pick by light” is also frequently referred to by the synonymous terms “pick to light” or “pick 2 light.”

A pick by light compartment indicator generally consists of at least one clearly visible eye-catching lamp and an acknowledgement button that the picker uses to confirm the withdrawal and communicates the inventory change to the warehouse management system in real time. Usually, the compartment indicators also have a numeric or alphanumeric display in order to show the picker the withdrawal quantity and other information if need be.

The term “put to light” refers to the reverse process from pick by light. In this case, the picker does not execute a withdrawal, but rather a placement of the article that is to be picked, controlled by a light indicator. The same compartment indicators are used as in a pick by light system.

Put to light systems are used in two-step picking. For this, multiple orders are first combined into what is referred to as a “batch” (“Los” fin German) and picked simultaneously in order to reduce transit times and picking times. Then the articles are divided up into the individual customer orders with the aid of the put to light system. One or more shelving units equipped with compartment indicators are installed at a distributing or sorting station. The picker then scans the articles from the batch container one after another. Then the compartment indicator of the associated distribution compartment is illuminated. The picker can assign and place the article quickly and reliably.

Pick by light systems and put to light systems can also be combined for an additional increase in efficiency. To accomplish this, a compartment indicator is installed on the back of the put to light distribution shelves. This indicates to packaging employees which of the distribution compartments already contain all of the articles associated with the order, i.e. have been completely picked. To indicate this, the eye-catching lamp (for example green) is illuminated. The packager withdraws the articles and confirms this using the acknowledgment button. The eye-catching lamp is switched off and the compartment is free for the next customer order.

Pick by light systems achieve their maximum efficiency with short travel paths and a high picking frequency at each storage location. In the reverse case, for example in a spare parts warehouse with long travel paths and a low picking frequency at each storage location, mobile picking systems offer a suitable solution option. For this, standardized or customer-specific vehicles are equipped with a power supply, WLAN connection, operator guidance, and compartment indicators.

The control software combines a number of picking orders in accordance with the number of available compartments on the picking vehicle. The picker then “marries” the individual orders to the compartments on the vehicle. By means of the operator guidance (visually via a display), the picker with the vehicle is guided in a path-optimized way from one withdrawal point to the next. The compartment indicators on the vehicle each indicate the correct storage compartment and the storage quantity. The storing action is communicated to the host system by means of the acknowledgment button and the next withdrawal point is displayed by means of the operator guidance. In this way, a picker can pick a number of customer orders simultaneously, traveling in a path-optimized way. The number of orders depends on the volume of articles and the design of the picking vehicle.

In order to be able to utilize all of the advantages of a pick by light system, the connection to the host system (usually a warehouse management system or ERP program) is of crucial importance. The order data must be transmitted quickly and reliably, which is also true for the acknowledgment, correction, or special function messages. The sequences and processes must be well-defined in advance and usually have to be adapted in a customer-specific way.

The object of the present invention is to provide a method and device that enable a simple and efficient preparation of ingredients for at least one dish.

This object is attained by the features of the independent claims. Advantageous embodiments are disclosed in the sub-claims that are dependent thereon.

The present invention relates to a method for preparing, in particular distributing, ingredients in a plurality of loading stations of a packaging line; multiple loading stations positioned in succession in a transport direction are provided and two or more ingredients (Z1 to Zm) are respectively kept on hand in the loading stations; and according to sorting features (O1 to Om), a predetermined assignment of the ingredients (Z1 to Zm) for recipes (R1 to Rn) is carried out from which the frequency with which they are ordered is known, wherein
the ingredients (Z1 to Zm) from a part of the recipes (R1 to Rn), which have a predetermined high frequency of orders, are first uniformly assigned to the loading stations according to a first sorting feature, and
according to a second sorting feature, these ingredients (Z1 to Zm) are assigned to the multiple successively positioned loading stations in descending order in the transport direction according to their weight, and
then the ingredients of the recipes with a lower frequency are assigned to the loading stations according to predetermined sorting features.

Through the uniform assignment of the ingredients of the most frequently ordered recipes, the most frequently ordered ingredients are distributed uniformly to the loading stations. This ensures that in the gripping or picking of the ingredients in the loading stations, they are gripped uniformly often in the individual loading stations so that the packaging line as a whole is very uniformly utilized and uniformly used to capacity. Since from a practical standpoint, a uniform distribution of all of the ingredients from all recipes is hardly possible or at the very least, the required computing effort is immense, the method according to the invention achieves a solution, which can be implemented simply and quickly and as a result, comes very close to an absolutely optimal solution. This is because the subsequent assignment of the ingredients of recipes that are not as popular cannot in fact always be performed in a uniformly perfect way so that as a result, the packaging line is used to capacity in a non-uniform way. But this has little influence because the low quantities of the ingredients of the less popular recipes can still be distributed somewhat uniformly and on the other hand, is not very important from an operational standpoint since these ingredients are picked less often than the ingredients of the popular recipes.

The assignment can be quickly adapted to changing ordering behavior of customers. This is particularly true when a new recipe that is very popular is offered. The method according to the invention makes it possible to react to this in an extremely short time.

In the context of the present invention, an ingredient is understood to be a unit of an ingredient, i.e. a quantity of a food that is required in a recipe. An ingredient can therefore be a single piece of food (e.g. a bell pepper) or also two or more pieces of a food (e.g. peas) or also several different foods (e.g. the herbs and vegetables for flavoring a soup), which are combined to form a single ingredient unit.

The invention can also be combined with a device and/or with a method for pre-portioning foods. In particular, a cutting device can be provided for automatically cutting foods into desired portions. In this connection, the entirety of DE 10 2008 056 541 A1, which was described at the beginning, is included herein by reference.

In addition, a device for pre-portioning and/or automatically selecting the correct quantity of ingredients can be provided, which for example automatically rejects portions of ingredients that are too large or too small.

But an ingredient can also be any other object such as a holiday card or kitchen utensil, which is used for the dish. For example, this can be a zucchini slicer for preparing zucchini noodles.

Two packages of the same ingredient, e.g. for different portion sizes, can constitute two different ingredients. This prevents a situation in which, when adapting a portion size to the number of persons, an employee has to reach into the same ingredient container twice in order to load a corresponding ingredient container. This would be disadvantageous when it comes to controlling loading procedures.

According to the first sorting feature (frequency), the ingredients (Z1 to Zm) from at least a part of the recipes (R1 to Rn) that are ordered the most frequently are uniformly distributed to the loading stations. The frequency of the orders of the individual recipes can be determined by evaluating the order quantities. The order quantities can be determined by evaluating current order quantities for a particular time interval such as daily, weekly, or monthly orders and/or based on past order quantities and/or based on market research results or empirical studies.

In particular, this should result in the fact that the ingredients of the recipes are distributed in the loading stations of the packaging line in such a way that approximately the same number of loading procedures p or picks is performed in each loading station. Thus in the ideal case, one loading procedure is performed in a loading station for each recipe, thus enabling an efficient picking of the ingredients.

As a result, the ingredients (Z1 to Zm) of the at least one part of the recipes (R1 to Rn) that are ordered the most frequently are first uniformly distributed to the loading stations.

The term “uniformly” means that a similar number of ingredients of a recipe and preferably only a single ingredient of a recipe is placed in an ingredient compartment so that the ingredients are distributed into the ingredient compartments of the loading station in such a way that all of the employees along the packaging line perform approximately the same number of loading procedures or picks. In addition, a stable and uniform employee workload is achieved, which enables effective, enjoyable work. In this way, a high and stable cycle time is achieved in the assembling and packaging of ingredients into the ingredient containers.

The loading quantity for all of the ingredient compartments is thus determined based on the frequency of the orders for the respective recipes.

Consequently, the loading of the ingredient compartments is determined by identifying the most frequently used recipes. The frequency with which each ingredient is used is thus assigned to the corresponding recipes. Then the ingredients of the recipes are assigned to the loading stations. This starts first with the ingredients of the recipe with the highest frequency.

The most frequently used recipes preferably include no more than 30% of the total number of recipes and preferably no more than 20% of the total number of recipes. [The total number of recipes is referred to twice; please check]

The part of the recipes (R1 to Rn) that are ordered the most frequently can include 5, 6, 7, 8, 9, 10, or 11 recipes.

Since the total number of recipes that are basically available can vary significantly, it can also be advantageous to define the most frequently used recipes based on a percentage of the total number of all available recipes. The most frequently used recipes, whose ingredients are distributed to the loading stations uniformly, therefore constitute no more than 10%, 15%, 20%, or 25% of all of the available recipes.

With ingredients that are used particularly often, it can also be advantageous to provide them in two or more loading stations from the outset.

According to the second sorting feature, the ingredient units (Z1 to Zm) are assigned to the multiple successively positioned loading stations in descending order in the transport direction according to their weight. The weight of the individual ingredients is known.

Taking the second sorting feature into account avoids damage to individual ingredients since the ingredients with the highest proportion by weight per “unit” are packed into a corresponding ingredient container first. The risk of heavier ingredients—due to their intrinsic weight—damaging lighter ingredients is thus significantly lower.

Preferably, the weight of the ingredients contained in the successively positioned loading stations decreases in the transport direction. This means that ingredients with a higher weight such as cans or the like are placed into the ingredient container first so that they cannot damage the lighter ingredients such as vegetables or the like during transport and packaging.

Preferably, the number of loading procedures in a loading station is equal to the number of ingredient containers to be loaded that are situated in the vicinity of this loading station. This means that in the optimal case p=z in the vicinity of a loading station, where p is the number of loading procedures and z is the number of ingredient containers.

In reality, this ideal case is difficult to implement. That is why preferably, p+/−1=z. This is referred to as balanced timing.

Preferably, a cycle time t of approximately two seconds (s) to 5 s and especially three seconds per loading procedure or pick is provided. This means that with a cycle time of three seconds per loading procedure and a buffer time of five seconds, this yields a total cycle time p*t+5 s=tₜₒₜ (total cycle time per loading station).

This means that the ingredients should be distributed to the loading stations in such a way that the packaging line is loaded efficiently and in particular, balanced timings are achieved.

According to a third sorting feature, a positioning of the same ingredients (Z1 to Zm) of different recipes (R1 to Rn) can take place at the same loading station. [What is the third sorting feature? Please check again.]

Identical ingredients of different recipes can therefore be provided in the same ingredient compartment at the same loading station, making it possible to reduce the number of required ingredient compartments.

This further increases the efficiency of the method according to the invention because fewer loading stations have to be provided in order to prepare the ingredients of all of the recipes since the same ingredients of different recipes are placed in the same ingredient compartment.

Then the ingredients of the recipe with the next lower frequency are assigned. This is repeated as often as necessary until the ingredients—for example of all of the recipes—have been assigned. The assignment of the ingredients is carried out according to the above-explained rules, with each ingredient being kept on hand in only a single ingredient compartment if possible. But this cannot always be achieved.

The ingredients of recipes that are not used as frequently can be distributed by first checking whether an ingredient is already present in a loading station. Only if this is the case is the corresponding ingredient then added to an ingredient compartment in a corresponding loading station according to the above-explained sorting features. This reduces the number of ingredient compartments and increases the efficiency of the method. It is thus possible to reduce the number of loading stations.

In addition, particular ingredients such as the herbs and vegetables for flavoring a soup are combined into a unit in advance and do not have to be withdrawn individually in a loading station. As a result, fewer loading steps are required and the loading of the ingredient containers can be carried out more quickly.

Optionally, still other sorting features can be used for loading the ingredient compartments of the individual loading stations. If the gripping (=picking) and setting down (=putting) of the ingredients is monitored with a camera, then it can be advantageous ingredients with similar appearances such as tomatoes and red apples to be provided at different loading stations so that it is not necessary to distinguish between optically similar ingredients in a loading station. This facilitates automatic optical recognition and increases its reliability.

In addition, the most frequently used ingredients can be positioned in easily accessible areas. Ingredients that are used in virtually every recipe, e.g. noodles or potatoes, should preferably be positioned easily within the employee's reach.

The employee's work would be further facilitated if particularly heavy ingredients were likewise positioned in easily accessible areas so that the employee can pick up the ingredient with the least amount of strain.

In addition and/or alternatively, a method for preparing, in particular assembling and packaging, ingredients for at least one dish can comprise the following steps:
a reading step in which a customer's order data are read, this order data comprising at least recipe data for the ingredients contained in a dish as well as customer data,
an assigning step in which at least one ingredient container is assigned predefined customer data,
a conveying step in which the ingredient container is conveyed to a transport device of a packaging line,
a positioning step in which at least one ingredient container is positioned in the region of a loading station of the packaging line by means of the transport device, this loading station having at least two ingredients or three, four, or more ingredients kept on hand in corresponding ingredient compartments,
an indicating step in which corresponding indicators of the ingredient container and ingredient compartments indicate whether they are included in the recipe data,
a loading step in which, if the ingredients are included in the recipe data, the ingredient container is loaded with the corresponding ingredient or ingredients in the loading station,
the repetition and execution of the positioning step, the indicating step, and the loading step until all of the ingredients included in the recipe data have been placed in the ingredient container.

In the context of the present invention, “loading” is understood to mean a movement by an employee with which a pre-proportioned ingredient from the loading station—or more precisely stated, from an ingredient compartment in the loading station—is placed in an ingredient container. Basically, the ingredients could also be supplied to the ingredient container mechanically. The mechanical gripping of different pre-proportioned foods, however, involves the risk that some of the food will be damaged. For example, it is very difficult to pick up and put down tomatoes without bruising them. If such a robotic arm is also supposed to pick up other ingredients such as red apples, which are similar in appearance to tomatoes, but are significantly harder, then the gripping procedure becomes even more complex. For this reason, with the method according to the invention, the ingredient containers are loaded manually. But this does not mean that the ingredient containers have to be exclusively loaded by hand. Easy-to-handle ingredients such as cans, packages of noodles, or the like can also be supplied to the ingredient container mechanically. Robotic arms or other feeder devices can be used for this, for example dispensers for supplying cans or other less sensitive foods such as garlic.

The method according to the invention achieves a high-frequency assembling and packaging of ingredients for one or more dishes.

The frequency is determined by the number of ingredient containers, the number of loading stations, the time for a loading procedure, and the number of ingredient compartments per loading station. The goal is to optimize the ingredient compartments in accordance with the frequency with which they appear in the recipes and the combinations thereof (menu plans) in order to ensure the best possible—in particular uniform—use to capacity of the loading stations, to minimize processing times, and thus to maximize the throughput.

For example, the reading step can be carried out directly from an enterprise resource planning (ERP) system.

The indicating step can preferably be carried out by means of a corresponding light-coding or color-coding of the ingredient container, for example by means of a pick by light device. A corresponding indicator device can have several indicator elements that are associated with the individual ingredient compartments of the loading stations. The indicator elements can be embodied to display certain colors, predetermined pictograms, or predetermined strings. The indicator device, however, can also be a projection device, which can illuminate the ingredient compartments individually. Examples of such projection devices include conventional video projectors or laser pointers.

Furthermore, the loading of the individual ingredient containers can also be controlled with a corresponding indicator device (put to light device).

Preferably, the ingredient compartments and the ingredients stored therein as well as the corresponding ingredient containers, which are to be loaded with this ingredient, are labeled with the same code (color, pictogram, or string).

This significantly reduces the search time for an employee who is filling the ingredient containers since he or she merely has to refer to the code in order to place the ingredients into ingredient containers that are likewise correspondingly labeled with the same code.

This practically eliminates withdrawal or picking errors in the form of incorrectly picked articles. It also significantly reduces the risk of picking errors in the form of overlooked ingredients.

The low error susceptibility in the withdrawal of ingredients from the ingredient compartments and in the loading of the ingredient compartments with the method according to the invention also achieves a higher level of customer satisfaction and generates fewer returns.

In this way, the ingredients can be assembled extremely efficiently and quickly.

In addition, thanks to the simplicity of the method, an employee requires only an extremely short training time, which also achieves a high degree of personnel flexibility.

Due to the resulting sharply reduced ordering times and order processing times, the method can be performed with a relatively high cycle time and also inexpensively.

This minimizes the error susceptibility when assembling the ingredients in the ingredient container and enables a high cycle time.

The method according to the invention therefore makes it possible to achieve a flexible series production of ingredient containers, which contain ingredients for a corresponding dish.

The number of possible dishes that can be produced in series is directly dependent on the ingredients that are prepared in the packaging line. A dish that can be made with the prepared ingredients can be made with the same productivity regardless of the number of units since recipe-specific setup times are not required.

This enables an efficient timing so that such a packaging line is embodied to be approximately two to four times more productive than known packaging lines.

In a closing step, the ingredient container can be closed by means of sewing, welding, gluing, or the like. In this way, the foods are protected during transport.

Optionally, in the closing step, the ingredient container could be filled with a protective gas such as nitrogen (N₂) or carbon dioxide (CO₂) just before being closed. This increases the shelf life of the food. A protective gas atmosphere could, for example, also be maintained by adding dry ice. This would have the further advantage of cooling the ingredients. [Ralph, why don't we use dry ice?]

In a packaging step, the ingredient container can be packed into a transport package in order to then be conveyed to a customer. The ingredients can thus be shipped immediately after completion of the method.

Preferably, the reading step can be repeated at least two, three, and preferably four times or also several times with other order data so that in each of the loading stations of the packaging line, two, three, and preferably four ingredient containers are loaded simultaneously. The reading step can also comprise the simultaneous, synchronous, or also time-delayed reading of a plurality of order data.

The reading step can be triggered by the reading of a corresponding label on an ingredient container that is supplied to the transport devices so that the respective order data relating to the supplied ingredient container are read. On the other hand, the order data can also be stored in the ingredient containers, e.g. by means of an RFID card, and can be read directly from the ingredient containers.

It is also possible to supply ingredient containers, which each have a certain, in particular machine-readable, label; this label is read and then the order data stored in the system are assigned to the label. Such a method requires only a few different labels to achieve and maintain a unique association between the order data and the ingredient containers. The labels on the ingredient containers can easily repeat on a regular or irregular basis.

It is also possible that after the assigning step, an inspection step is performed in which the customer information of the ingredient containers is checked for whether the correct ingredient containers according to the order have been added to the system. For this purpose, the ingredient containers are labeled with corresponding identifiers such as ID numbers.

In the ingredient compartments, the ingredients are already pre-portioned for a dish for one person and preferably also for two or more persons.

One or more successive loading stations B can be positioned along the packaging line in a transport direction or more precisely stated, one to x of them, where x is the number of loading stations.

In addition, the ingredient containers can be detected in a detection step in the individual loading stations.

For this purpose, receiving sections for receiving the ingredient containers can be provided on the transport device. Each receiving section can be provided with a QR code.

The corresponding ingredient containers can be provided with ID numbers. These are connected to the QR codes of the receiving sections.

In this way, it is possible to detect each ingredient container and in particular its position during the process.

In the following, rules are presented on which advantageous embodiments of the method according to the invention are based.

1. Preferably, a recipe should not include more ingredients than the loading stations that are provided in the packaging line in order to avoid double loading procedures, which could be incorporated into the process and detected only with great difficulty. A “double loading procedure” is understood to be reaching into an ingredient compartment of a loading station twice within the total cycle time tₜₒₜ.

2. The number of recipes should generally be greater than the number of ingredient compartments per loading station. This is possible because more and more recipes have an intersecting set of shared ingredients.

3. The ingredient compartments of the loading stations are preferably filled in such a way that the loading stations situated at the start of the packaging line or more precisely stated, their ingredient compartments, are loaded with heavier ingredients and the weight of the ingredients in the ingredient compartments decreases along the packaging line in the transport direction. This prevents heavier ingredients such as canned tomatoes from damaging lighter ingredients due to their intrinsic weight.

4. Also preferably, the often-needed and the seldom-needed ingredients are distributed uniformly throughout the loading stations in the packaging line. In this connection, it is also possible for the ingredients that are needed more frequently and the ingredients that have a higher weight to be placed in the ingredient compartments situated toward the bottom in the vertical direction so that an employee has them quickly within reach for loading the corresponding ingredient containers.

5. In a loading station, the number of picks per total cycle can preferably correspond to the number of ingredient containers or more precisely stated, the number of ingredient containers +/−1.

6. An average frequency of the recipes or of the selected recipes (Z1, Z2 . . . Zn) can also be known. Like rules 1 to 5, this contributes to balancing out the ingredient compartments of the loading stations.

7. Furthermore, additional ingredient compartments can be provided in order to position certain ingredients, which are needed more frequently, in a plurality of loading stations in order to increase the portion size.

8. Ingredients of the same type, but different portion size are considered to be different ingredients and are to be respectively placed in separate ingredient compartments.

Also according to the invention, a method is provided for optically detecting ingredients in a packaging line; the packaging line comprises a plurality of loading stations positioned successively in a transport direction and a transport device, which is positioned along the loading stations and is for moving ingredient containers along the transport direction; at least two or more ingredients (Z1 to Zm) are kept on hand in the loading stations; the loading stations are scanned with at least one camera; and an image is generated, which is analyzed by means of an optical object recognition in order to recognize a picked ingredient.

In the context of the present invention, a pattern representing an ingredient object is described by a list with a plurality of features of the optical image of an ingredient. This list of features constitutes a feature vector.

Feature vectors facilitate an automatic classification since they systematize the properties that are to be classified.

In the context of the present invention, an “ingredient object” is understood to mean the technical data description of the ingredients. This comprises an identification for the respective object, e.g. its respective name (e.g. tomato, cucumber, banana, noodles), and a corresponding characteristic pattern that is described by means of a feature vector. A characteristic pattern is detected from among a multitude of patterns of ingredients, for example by averaging or by another selection of the patterns that are typical for this ingredient.

In the context of the present invention, a characteristic pattern can be established for the ingredient “apple,” but it is also possible to established characteristic patterns that are much more specific for individual types of apple. In other words, this means that characteristic patterns can be established both for a particular ingredient group and for subgroups of these particular ingredient groups.

A position of the ingredient object can be detected in the images captured with the camera; the direction of the ingredient object can be determined based on this position in the image, the focal length, the imaging scale, and the position and viewing direction of the camera.

In this way, it is possible to determine the direction of the position of the picked ingredient in relation to the camera.

Furthermore, at least two images can be produced simultaneously with at least two cameras, the two cameras forming a stereo camera so that the coordinates of the ingredient object can be determined by means of triangulation.

According to one embodiment, it is possible based on these image pairs to determine for example the respective position of the ingredient object in the images captured with the camera and based on these positions, viewing directions, focal lengths, imaging scales, and positions of the cameras, it is possible to determine the position of the ingredient object. The position can be determined by means of the intersection point of the directions of the ingredient object.

In addition, multiple image pairs of a stereo camera can be captured spaced apart in time from one another and based on these image pairs, the spatial coordinates of the ingredient object can be determined so that the space-time coordinates of the ingredient objects in the individual image pairs are known.

“Spaced apart in time” means that the images are captured at different points in time.

Basically, it is also possible to determine the spatial coordinates of the ingredient object by means of a single camera (direction) and a distance-measuring device, e.g. with an ultrasonic sensor. But the use of several stationary cameras solely as sensors is preferable because they are significantly less error prone and lower maintenance since there are no moving parts. In addition, the cameras can scan a relatively large area of a packaging line.

A gripping element with a predetermined marking can be used and the marking of the gripping element is detected. The gripping element can be the arm of an operator that grips the ingredient. In the context of the invention, the gripping element can also be a robotic arm.

Such a marking can be embodied in the form of an easily recognizable “pattern” such as horizontal and/or vertical stripes on an employee's sleeve, preferably with colored markings. Preferably, easy-to-detect colors are provided, i.e. colors that preferably do not occur in employee clothing, ingredient objects, and machines or equipment in the monitored area, e.g. unusual signal colors in yellow, green, orange, purple, etc. The signal colors are colors that are not otherwise present in the surroundings of the packaging station.

The above-described methods relate to the loading of ingredient containers. The individual method steps of these methods can be arbitrarily combined with one another where technically feasible.

According to another aspect of the present invention, a device for preparing ingredients for at least one dish is provided. It comprises:
a transport device,
a plurality of loading stations positioned successively along the transport device in a transport direction and at least two ingredients and preferably at least four ingredients are kept on hand in a loading station,
a position determining device for determining the position of the ingredient container relative to the loading stations,
an indicator device, which marks an ingredient in the loading station that is predetermined by a recipe if the ingredient container is present in the corresponding loading station.

This device executes a coordinated indication of the ingredient to be gripped and transportation of the corresponding ingredient containers. This enables an effective loading of the ingredient containers with ingredients.

Furthermore, transport containers can be provided in which ingredient containers are placed; the refrigerated transport device is provided with a separate refrigerated ingredient container, which is loaded with refrigerated ingredients at the refrigerated loading station;

for the transport device, a separate ingredient container is provided, which is loaded with non-refrigerated ingredients at the loading station; and the refrigerated ingredient container and the ingredient container are placed in a transport container.

In addition, a frozen line can be provided with a frozen transport device and with a plurality of loading stations positioned successively along the frozen transport device in a transport direction; at least two or more ingredients are kept on hand in each loading station; and the frozen line is embodied separately or as a component of the refrigerated line.

The transport device and/or the refrigerated transport device and/or the frozen transport device can extend along a linear transport direction or along branched transport directions.

Preferably, refrigerated protein ingredients such as milk or meat can be supplied to the ingredient container or preferably the transport package in a separate packaging line, i.e. the refrigerated line and/or frozen line. In this case, protein ingredients can be protected with thermal insulation, in particular an insulated package.

In particular, multiple packaging lines or production lines according to the invention can be combined with one another, for example in order to package protein ingredients (meat, fish, dairy products, etc.) from a refrigerating unit or another refrigerated packaging line in a separate insulated package (Woolcool or the like with a cooling package), which is then loaded similarly to an ingredient container.

The ingredient compartments for refrigerated ingredients such as protein ingredients can be positioned in a refrigerated room. The transport device is positioned adjacent to the refrigerated room. In the region of the ingredient compartments, openings are provided in the refrigerated room so that the ingredients can be taken out of the ingredient compartments. In the region of these openings, an air curtain, a curtain made of strings, or a curtain made of belts can be provided in order to minimize the air exchange between the cool air of the refrigerated room and the warmer air of the adjacent space in which the transport device is situated.

A transport package can then contain a preferably reusable insulated package with protein ingredients for one or more dishes, for example two preferably reusable ingredient containers.

Printed recipe instructions for the dishes contained in the transport container can also be provided in it.

In particular, a computer system or control unit is provided, which receives the customer's order and controls the packaging line accordingly.

Furthermore, a device for preparing ingredients for at least one dish is additionally and/or alternatively provided, which can preferably be combined with the above-described device. This device comprises a reading device for reading a customer's order data, a transport device, a plurality of loading stations positioned successively along the transport device in a transport direction with at least two ingredients and preferably at least four ingredients being kept on hand in a loading station, a position determining device for determining the position of the ingredient container relative to the loading stations, and an indicator device, which marks an ingredient in the loading station that is predetermined by a recipe if the ingredient container is present in the corresponding loading station.

The above-demonstrated advantages of the method according to the invention also apply analogously to the device according to the invention and are therefore not listed again separately at this point.

The indicator device can comprise a pick by light device and/or a put by light device and/or the indicator device can have a plurality of indicator elements respectively assigned to an ingredient compartment of the loading station and is particularly embodied to display predetermined colors and/or predetermined pictograms and/or predetermined strings, and/or the indicator device can comprise a projection device that can be used to individually illuminate the ingredient compartments of the loading station.

In addition, the position determining device can have one or more sensors for determining the position of the respective ingredient containers in the region of each loading station, and/or can have one or more sensors for
identification of an ingredient during the gripping thereof by means of automatic image analysis,
verification of the quality of an ingredient by means of automatic image analysis, and
determination of the space-time coordinates of a gripped ingredient.

The position of each ingredient container relative to the transport device can be determined at least once and other positions along the transport device can be determined by means of a controlled transport of the ingredient containers.

In addition, a withdrawal detection device can be provided in order to detect a withdrawal of ingredients from ingredient containers in the loading stations.

The withdrawal detection device can have a proximity sensor, in particular a capacitive proximity sensor, and/or a camera.

In addition, a loading detection device can be provided for detecting a loading of the ingredient containers with ingredients in the loading stations.

The loading detection device can have a proximity sensor, in particular a capacitive proximity sensor, and/or a camera.

In particular, an optical monitoring device can be provided, which has one or more cameras and an evaluation device and is able to detect one or more of the following actions:
withdrawal of an ingredient from an ingredient compartment,
loading of one of the ingredient containers,
positioning of one of the ingredient containers along the transport device,
identification of an ingredient during the gripping thereof by means of automatic image analysis,
verification of the quality of an ingredient by means of automatic image analysis, and
determination of the space-time coordinates of a gripped ingredient and/or of one of the ingredient containers.

The optical monitoring device can have a module for detecting the individual ingredients and/or for detecting the ingredient containers.

The monitoring device can be a machine learning system such as a neural network, particularly for learning patterns of the individual ingredients.

The evaluation device can be provided with a module used to compare the actual loading to a predetermined loading of the respective ingredient containers and in the event of a discrepancy, a message is issued or a predetermined action is prompted.

This means that with a single monitoring system, it is possible to detect and evaluate the withdrawal of ingredients from the ingredient compartments, the loading of the ingredient containers, and the positioning of the ingredient containers. Such an optical monitoring system is thus able to detect which ingredients are present in which ingredient container.

The device can have a monitoring module for identifying the ingredient and/or determining the coordinates of the ingredient by means of automatic image analysis; this monitoring module is coupled to a triggering module and/or a control unit for controlling the indicator device in such a way that the monitoring module is started either when a gripping action is detected by the triggering module and/or when an ingredient to be gripped is marked by the indicator device.

The automatic image analysis can create a considerable demand for computing capacity. Because the monitoring module is triggered by a gripping event, it is possible to significantly reduce the required computing capacity and a plurality of monitoring modules can be operated simultaneously in order to monitor a plurality of loading stations.

For example, the monitoring module can identify the individual ingredients and/or the ingredient container by means of a pattern comparison.

Such a monitoring module can be embodied as a machine learning system such as a neural network. The individual ingredients can be trained into such a machine learning system once so that from this point on, the optical monitoring module automatically detects the ingredients every time they come into the camera's field of view.

Preferably, the user of this device is provided with clothing that has sleeves with one or more markings that are easily recognizable to a machine. If this marking is within the image captured by the camera, then the pattern recognition module can easily identify the region of the image in which the ingredient is located so that the analysis of the pattern recognition module can concentrate on this region.

The device can have a plurality of cameras, each of which scans a monitoring cell of a loading station. The monitoring cell includes the region of the transport device in the loading station and ingredient compartments positioned in the loading station; and the cameras are positioned in such a way that sections of the respective monitoring cells are each scanned by at least two cameras. On the one hand, this makes it possible to determine the spatial coordinates of the detected object, with the two cameras being used like a stereo camera. On the other hand, the ingredient itself can still be detected and identified if the ingredient is concealed from the viewing direction of one of the two cameras since it can be detected by the other camera.

The cameras, which are provided to supply the image data for the automatic image analysis, are preferably stationary cameras and/or cameras with a fixed focal length. Stationary cameras, particularly with a fixed focal length, are very low-maintenance since there are no moving parts.

The monitoring device can be connected to the control unit in such a way that the information about the ingredients with which the respective loading station is filled and/or about which ingredient is marked with the indicator device is available to the monitoring device in the automatic image analysis and this information is taken into account in the image analysis. For example, this information can be taken into account to the effect that a comparison of the detected pattern is made only relative to the ingredient objects whose corresponding ingredients are present in the loading station or relative to the ingredient object that corresponds to the ingredient that is to be gripped. This reduces the number of comparisons significantly, thus reducing the required computing power and allowing the detection to take place much more quickly and reliably.

The monitoring device can have a selection module, which receives the image data from the individual cameras and for the monitoring modules, which are each assigned to a respective loading station or monitoring cell, selects, possibly filters, and/or pre-processes this image data and forwards it to the monitoring modules. Through the selection, only image data that show at least a section of a monitoring cell that is to be monitored by the respective monitoring module are forwarded. The image data can also be reduced by reducing the number of images of the respective image data stream and/or by creating a snippet and only forwarding this snippet. This ensures an efficient forwarding and processing of image data streams.

The evaluation device can be provided with a module that is used to compare the actual loading to a predetermined loading of the respective ingredient containers. In the event of a discrepancy, a message can be issued. Also in the event of a discrepancy, a predetermined action can be prompted, for example an incorrectly loaded ingredient container can be removed and the loading of the corresponding order can be started over again.

The loading step in a loading station can be checked by means of corresponding sensors in an ingredient detection step. To accomplish this, a camera is preferably provided, with or without a motion sensor for a withdrawal detection device, which detects whether the correct ingredient and/or the correct ingredient quantity for an ingredient container have actually been withdrawn from the loading station. Alternatively and significantly less reliably, it is also possible to provide motion sensors for the withdrawal detection device.

By means of such a withdrawal detection step in the individual loading stations, the cycle time of the current method can also be adapted in order to prevent ingredient containers that have not yet been completely packed from being removed from a loading station and already conveyed to the next loading station.

By means of such a withdrawal detection step, it is also possible to provide direct feedback to a warehouse management system in order to acknowledge the withdrawal, to fill inventories and ingredient compartments of a loading station, and if need be to perform corrections in the event of a shortage.

As explained above, the withdrawal detection device can have a motion sensor or proximity sensor, which is in particular embodied in the form of a capacitive proximity sensor. The withdrawal detection device can also have a camera that is used to optically detect the corresponding ingredients.

It is also possible to provide a loading detection device in order to detect the loading of the ingredient containers with ingredients in the loading stations. The loading detection device in turn can have a proximity sensor, in particular a capacitive proximity sensor, and/or a camera.

Preferably, an assigning device for assigning customer data to at least one ingredient container can be provided, this assigning device being a labeling device, e.g. a printing device for printing a machine-readable code, or a memory device for storing customer data in a machine-readable memory that is or can be connected to the ingredient container, or a detection device, which reads a label affixed to the ingredient container and assigns particular customer data to it.

In a preferred embodiment, however, only cameras are provided for monitoring the gripping (=picking) and/or setting down (=putting) of the ingredients. With the cameras, it is possible to monitor many aspects at the same time, e.g. the identification of the gripped ingredients, the movement thereof during the gripping and setting down, the correct loading of the ingredient containers, quality control, and the movement of the ingredient containers. In addition, the data detected by means of this can be used in a merchandise management system, e.g. for automatic orders of ingredients. The cameras form a very reliable, precise, versatile, and durably functioning sensor system. They can also be used to identify barcodes on the ingredient containers or on the packaging trays. Consequently, no further sensors are required.

In addition, an inspection device can be provided after the last loading station in the transport direction in order to inspect the contents of the respective ingredient container; preferably, the inspection device is a scale.

One or more loading stations can have refrigerating units for refrigerating ingredients or foods and/or gas treatment devices for gas-treating ingredients or foods with nitrogen or carbon dioxide.

A loading station can have a plurality of ingredient compartments positioned next to and on top of one another.

According to a particularly preferred aspect of the present invention, a system is provided for preparing ingredients for at least one dish. Such a system comprises at least two devices that are embodied in accordance with the device presented above; each device is embodied for loading an ingredient container and a packaging device is provided for automatically packaging the ingredient containers assigned to a dish into a shared transport package.

Such a system can comprise a second device, e.g. a refrigerated packaging line for protein ingredients, which is arranged, for example, in mirror image fashion relative to the first packaging line in such a way that the ingredients and the refrigerated protein ingredients are “married” or combined in the vicinity of the packaging device.

The present invention will be explained in greater detail below based on the drawings. These drawings show the following:

According to another aspect of the present invention, a method for monitoring packaged goods on a transport device is provided and each element of the packaged goods is provided with a particular identification marker. The number of different identification markers is limited and the chronological order with which the different identification markers are provided on the individual elements of the packaged goods is maintained. The method comprises the following steps:
detection with at least one camera of identification markers of a sequence of successive elements of the packaged goods, and
identification of at least one of the elements—whose identification marker has been detected—based on a comparison of the identification markers of the detected sequence to the maintained chronological order of identification markers.

Because in a sequence of successive elements of the packaged goods, the identification markers are detected with a camera, this sequence of identification markers can be identified in the maintained chronological order of identification markers with which the identification markers are placed on the elements of the packaged goods. By means of this, it is possible to uniquely identify the sequence in a series of elements of the packaged goods that is significantly larger than the sequence and when the sequence is uniquely identified, the individual element can also be uniquely identified.

The maintained chronological order of identification markers is preferably embodied so that a sequence with a predetermined number of identification markers only occurs a single time. But this does not mean that the individual identification markers must be contained in it only once. They can appear multiple times in the maintained chronological order, just in different sequences each time. This makes it possible, with a relatively small number of identification markers, to uniquely mark and identify a much larger number of elements.

If, based on the cameras and their viewing direction, a determination is made as to the approximate position of the sequence of elements whose identification markers are being detected, then taking this position into account, it is possible to use a particular sequence multiple times along the transport device provided that a certain minimum distance is maintained between the individual identical sequences in the maintained chronological order so that by taking into account the position of the sequence on the transport device, it is possible to isolate the corresponding position in the maintained chronological order of identification markers. This detected position can thus be used to eliminate ambiguities. Accomplishing this requires only a very rough detection of the position. Since the position and the viewing direction of the cameras are generally known, the position that they detect is generally also known. If several cameras are positioned along the transport device, then as a position indication, just the camera with which the packaged goods item has been scanned is sufficient as a position indication.

Since the number of identification markers can be kept small, it is possible to use relatively simple identification markers, which can be simply and reliably identified from a greater distance by means of a camera. For example, these identification markers can be different colors or line elements. For example, the lines have a line thickness of at least 3 mm, preferably at least 4 mm or at least 5 mm. Such line thicknesses or dot sizes can be reliably detected from a relatively long distance (e.g. 5 m) by means of commercially available cameras without having to use special lenses for this.

Preferably, each individual identification marker of the maintained chronological order is assigned an identification number for identifying one of the elements of the packaged goods. Based on this identification number, the respective element of the packaged goods can then be identified and if need be connected to additional information, e.g. a particular order or a particular recipe.

This method can be used in combination with the above-explained method for preparing ingredients and/or with the above-explained device for preparing ingredients; the ingredient containers are the elements of the packaged goods that are to be monitored and/or identified as they are conveyed along the transport device.

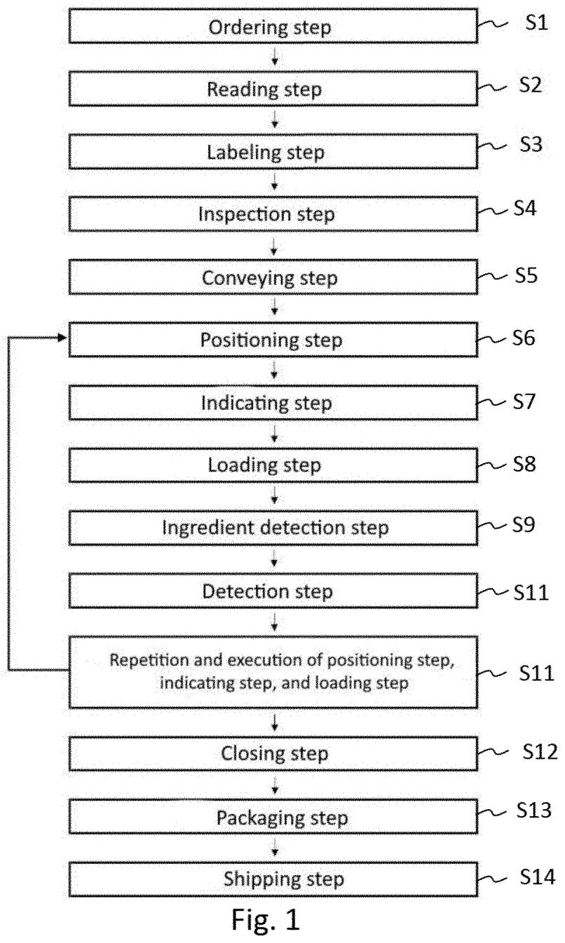

FIG. 1 shows a flow chart of a method according to the invention for preparing ingredients for at least one dish,

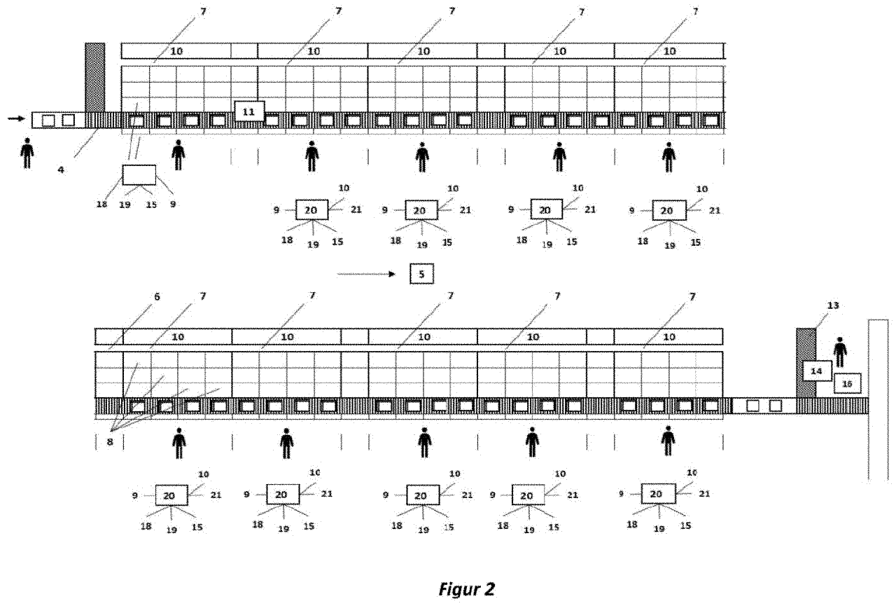

FIG. 2 shows a schematic depiction of a device according to the invention for preparing ingredients for at least one dish

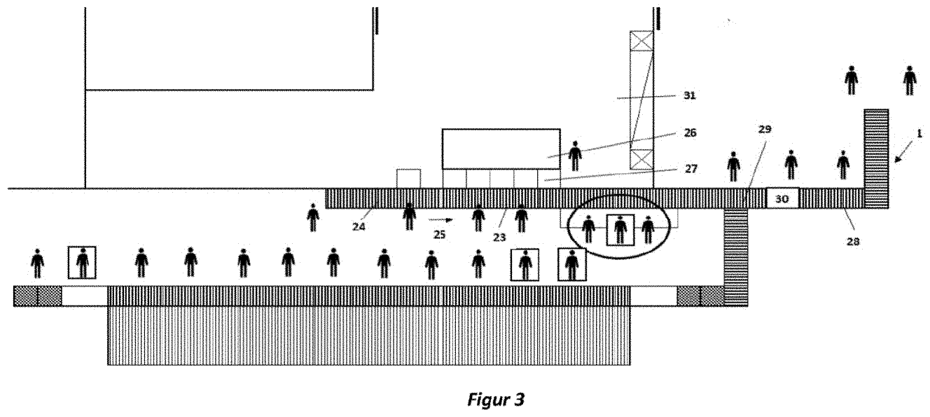

FIG. 3 shows a schematic depiction of another exemplary embodiment of a device according to the invention for preparing ingredients for at least one dish,

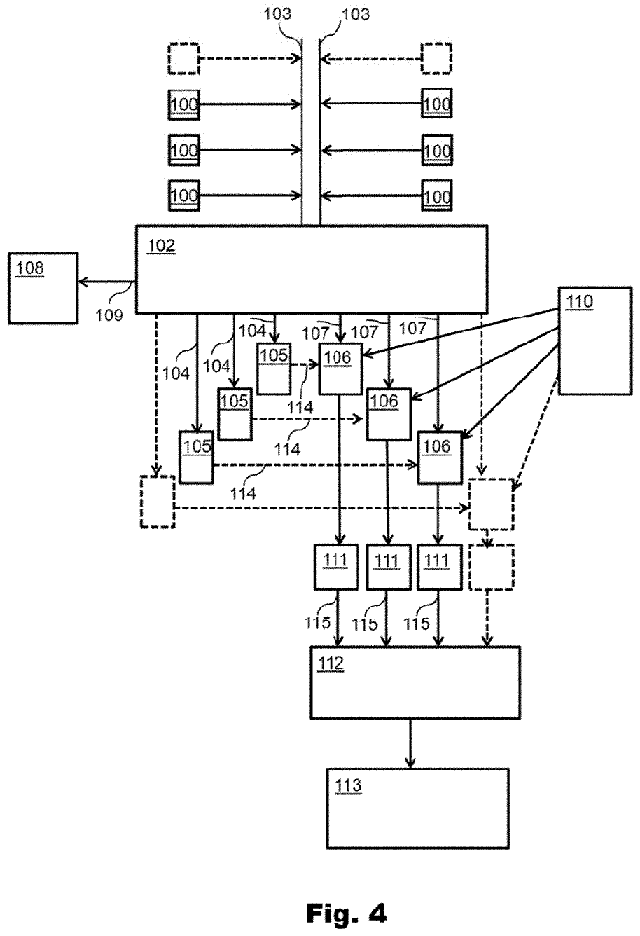

FIG. 4 shows a schematic depiction of a piece of monitoring software according to the invention composed of a plurality of modules,

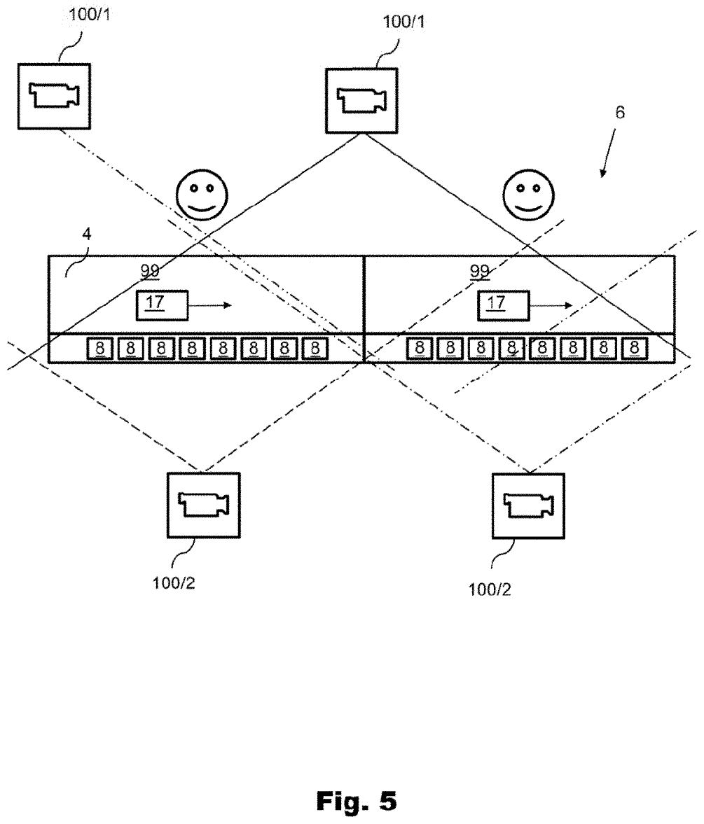

FIG. 5 shows a schematic depiction of monitoring cells of a packaging line with the cameras installed for this purpose,

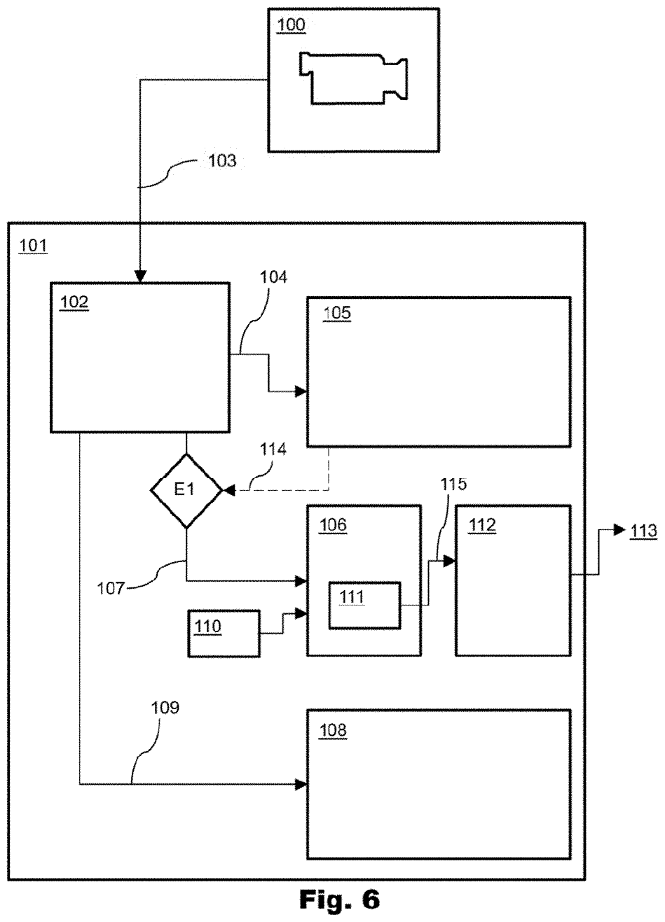

FIG. 6 shows a schematic depiction a piece of monitoring software according to the invention for an individual monitoring cell, which software is composed of a plurality of modules, and

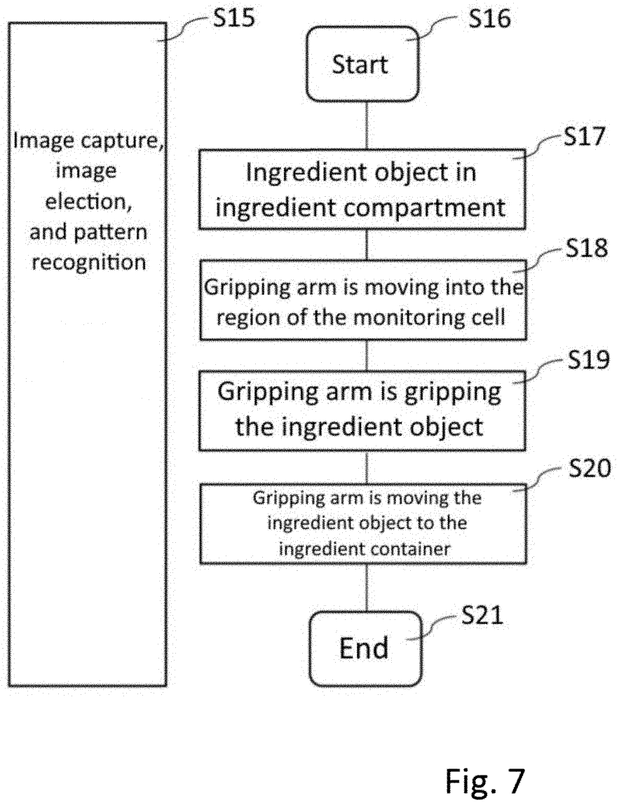

FIG. 7 shows a flow chart of a method according to the invention for optically monitoring ingredients.

A device 1 according to the invention for preparing, in particular for assembling and packaging, ingredients for dishes, will be described below based on an exemplary embodiment (FIG. 2).

The device 1 includes a recording device (not shown), which receives, comprehends, and evaluates orders sent in by customers, for example via the Internet on a website. For this purpose, the recording device has at least one corresponding interface.

The recording device then sends order data, which include the recipe data and the customer data, to a control unit (not shown) of the device 1.

In addition, the recording device is embodied to create a corresponding machine-readable code or label such as a QR code, a barcode, or an RFID card. The code contains the information or data about the ingredients that are contained in the ordered dish.

Alternatively, this information can also be forwarded by the control unit to the production line without a QR code, for example by scanning information attached to ingredient containers, and the device is controlled by means of this information or order data.

In addition, an assigning device is provided. The assigning device is embodied to assign the corresponding customer data to at least one or more ingredient containers.

The assigning device can have a labeling device, e.g. a printing device for printing a machine-readable code, so that on the ingredient container, the corresponding assignments of customer data can be read on the ingredient container with a corresponding reader device.

In addition and/or alternatively, the assigning device can be embodied as a memory device, e.g. RFID chip, for storing the customer data in a machine-readable memory that is or can be connected to the ingredient container.

In addition and/or alternatively, the assigning device can be embodied as a detection device, which reads a label affixed to the ingredient container 17 and associates the particular customer data with this label.

For example, the detection device is positioned in the region in front of a first loading station 7 of the packaging line 6, which checks the ingredient containers 17 for whether the packaging line 6 has been supplied with the correct ingredient containers 17.

By means of a labeling device 2, ingredient containers 17 are labeled with the customer data in the form of ID numbers. This occurs by printing and affixing a sticker to the respective ingredient container 17. The sticker can subsequently also be used to close the ingredient container 17. For example, the customer data or information comprises the name and address of the customer, the date of the order, the desired delivery date, etc. This labeling device is a component of the above-explained assigning device.

For example, the ingredient containers 17 can be embodied as paper bags or as reusable plastic containers.

In addition, a feeder device 3 can be provided for feeding the ingredient containers 17 to a transport device 4. The feeder device 3 is optional and can be a conveyor device or robotic device. The feeding of the ingredient containers 17 to the transport device 4 can also be performed manually.

The transport device 4 is preferably embodied as a conveyor belt for transporting or conveying the ingredient containers 17 along a packaging line 6 in a transport direction 5. For receiving the ingredient containers 17, the transport device 4 has receiving sections for receiving an ingredient container 17. Each receiving section is provided with a QR code. For example, such a receiving section is embodied as a stable transport tray.

The transport device can be a belt conveyor or conveyor belt or also a roller conveyor, a roller track, ball track, or pneumatic conveyor.

These QR codes of the receiving sections are connected to the ID numbers of the ingredient containers 17.

For example, the packaging line 6 comprises ten loading stations 7 positioned successively along the transport device 4 in the transport direction 5. A “loading station” refers to a shelving unit with ingredient compartments in which the ingredients are kept on hand as well as a corresponding section of the transport device in the vicinity of the shelving unit. In FIG. 2, the packaging line 6 is shown in two sections to facilitate its graphic depiction. In reality, it is a single packaging line 6.

In the present exemplary embodiment, by means of the transport device 4, four ingredient containers 17 can be simultaneously positioned in the region of each loading station 7 by means of the transport device 4.

In the loading station 7 for example twelve ingredient compartments 8 are positioned in a shelving unit. Various foods and/or pre-portioned ingredients for a particular recipe, preferably in interchangeable trays, are positioned or kept on hand in the individual ingredient compartments 8. For example, a tray is a receptacle for a box that is open at the top. For example, the ingredient compartments 8 are arranged in three rows, with four ingredient compartments 8 each.

For example, the shelving units are embodied as gravity shelves. A shelving system of this kind uses a gravity-driven discharge of products. The flow of products can be controlled by means of appropriately selected storage racks constructed from the gravity shelves. An advantage of such shelving units is an effective utilization of storage space and the possibility of using shelving units for storing both heavy and light loads.

Each loading station 7 has an indicator device 9, which preferably comprises a pick by light device 18 and a put by light device 19. The indicator device is embodied to mark an ingredient or an ingredient compartment of the loading station that is predetermined by a recipe when the ingredient container 17 is positioned in the corresponding loading station.

Alternatively to the put by light device 19, the ingredient containers 17 can also be labeled by means of corresponding stickers or the like. In addition, it is also possible to label the receiving sections and/or transport trays of the transport device. For example, each receiving section can be embodied to receive a predetermined number of ingredient containers 17. The corresponding places for receiving each of the ingredient containers are provided with a marking, which corresponds to the marking that is produced by the put by light device. It is therefore unnecessary for the ingredient containers themselves to be marked. The markings on the reusable receiving sections can be affixed to them permanently.

The indicator device 9 is embodied in such a way that the put by light device 19 can cause the ingredient containers 17 to be indicated, marked, or labeled with four different colors and the control unit can evaluate the recipe data in such a way that the pick by light device 18 indicates, marks, or labels the ingredient compartments 8 with color in such a way that an employee is provided with colored indications showing which ingredients should be placed into the corresponding ingredient containers 17.

Alternatively and/or additionally, the indicator device can have a plurality of indicator elements, which are each associated with or positioned on an ingredient compartment of the loading station, which indicator elements are in particular embodied to display predetermined colors and/or predetermined pictograms and/or predetermined strings. Corresponding markings can also be provided on the ingredient containers 17 and/or the receiving sections of the transport device. The indicator elements can have small screens, e.g. LCD or OLED screens, or light-emitting diodes.

Alternatively and/or additionally, the indicator device can also comprise a projection device that can be used to individually illuminate the ingredient compartments of the loading station. Such a projection device is relatively expensive, but can be used to mark a plurality of ingredient compartments simultaneously.

In addition, in each loading station 7, a withdrawal detection device 10 is provided, which comprises for example two sensors (not shown) per ingredient compartment for detecting the gripping movement of the employee into the ingredient compartment. In this way, a check is performed as to whether an employee has also withdrawn the corresponding ingredients from the ingredient compartments 8. It is then assumed that the employee has placed the corresponding ingredient in the indicated ingredient container 17.

The withdrawal detection device can respectively have a proximity sensor, in particular a capacitive proximity sensor, a photoelectric sensor, and/or one or more cameras.

In addition, an optical monitoring device is provided, which has one or more cameras and an evaluation device and can be used to detect one or more of the following actions:
withdrawal of an ingredient from an ingredient compartment,
loading of one of the ingredient containers 17,
positioning of one of the ingredient containers 17 along the transport device.

The optical monitoring device has a pattern recognition module for recognizing the individual ingredients and/or for recognizing the ingredient containers 17.

The monitoring device can have a machine learning system such as a neural network, particularly for learning patterns of the individual ingredients.

The evaluation device can be provided with a module used to compare the actual loading to a predetermined loading of the respective ingredient containers 17 and in the event of a discrepancy, a message is issued or a predetermined action is prompted.

In the transport direction, preferably after or in the vicinity of each loading station, an optical monitoring device 11 is provided for example in order to detect the QR codes of the receiving sections. It is thus possible, for example, to simply track the position of each ingredient container 17 because the QR codes are connected to the ID numbers of the ingredient containers 17 as long as the latter are positioned on the receiving sections.

One or more of the loading stations 7 can be provided with refrigerating units for refrigerating the ingredients that are kept on hand therein.

One or more of the loading stations 7 can be provided with gas treatment devices for keeping the ingredients stored therein fresh by means of gas, for example carbon dioxide or nitrogen.

Furthermore, an inspection device is provided after the last loading station in the transport direction in order to inspect the contents of the respective ingredient container; preferably, the inspection device is a scale.

At the end of the packaging line 6 in the transport direction 5, a closing device 13 is provided for closing the ingredient containers 17. For example, the closing can be carried out by means of gluing, by sticking on labels, sewing, welding, etc. The closing device is thus a welding device for welding plastic bags and/or a sewing device for sewing bags shut and/or a gluing device.

After the closing device in the transport direction 5, an additional packaging device is provided for packaging the ingredient containers 17 in transport containers.

In particular according to the invention, a system for preparing ingredients for at least one dish is provided; the system comprises at least two or more devices in accordance with the above-described device. Each device is embodied for loading at least one ingredient container 17 and the packaging device for automatically packaging the ingredient container 17 that is assigned to a dish is then provided in order to package the ingredient containers 17 into a shared transport package.

According to an exemplary embodiment that is not shown and is particularly advantageous, another device, a protein packaging line, is independent of the packaging line 6 and has refrigerating units and perishable protein ingredients such as milk or meat are assembled in it.

These protein ingredients can be insulated with a corresponding insulated package such as so-called Woolcool packs and provided with a cooling element and can be brought together with the ingredient containers 17 in a transport container 20 in the vicinity of a packaging device 14.

The ingredients in the ingredient container 17, which have been assembled in the packaging line 6, and the protein ingredients are then contained in this transport container 20.

Furthermore, an additional final inspection device 16 is provided to verify—for example by scanning the corresponding barcodes—that one or more ingredient containers 17 are positioned in the correct transport container with the corresponding order data according to a predetermined customer order.

These days, it is customary to use cooling elements for shipping foods. These cooling elements are single-use or reusable cooling elements, which are filled with a cooling fluid or cooling gel. But a cooling element can also be a cooling container for containing dry ice. This cooling container has walls with a thermal insulation layer; preferably, a cooling wall is less thermally insulated than the remaining walls. The cold of the dry ice dissipates outward through this cooling wall. The cooling container has one or more openings through which the CO₂ gas that is produced by the sublimation of the dry ice can escape. In some foods, an atmosphere enriched with CO₂ produces a further delayed aging.

For example, the cooling container can be embodied of particle foam (e.g. ePS, ePP) since a particle foam component of this kind is inexpensive to manufacture and also provides outstanding thermal insulation. The cooling wall can be composed of a different material, e.g. an injection molded plastic component, which is thin-walled, stable, and exhibits significantly greater thermal conductivity than the particle foam. A cooling container of this kind can be used repeatedly in a multiple-use system.

When using dry ice, the ingredient container 17 should have a certain degree of gas permeability in order to avoid excess pressure.

A method according to the invention for preparing or more precisely stated, for assembling and packaging ingredients for dishes will be described below (FIG. 1).

It includes the provision that the ingredients in the ingredient compartments of the loading stations are balanced in such a way that foods that are frequently needed in many dishes are distributed uniformly throughout the individual loading stations of the packaging line. Among other things, this prevents one employee from having to incessantly load all of the ingredient containers while other employees only seldom have to load anything.

In particular, the loading stations of the packaging line are embodied so as to ensure that over a broad spectrum of recipes, approximately the same number of loading procedures p or picks are performed per loading station. Thus in the ideal case, for each recipe, one loading procedure is carried out in a loading station.

This means that preferably, in one loading station, the number of loading procedures is equal to the number of ingredient containers to be loaded, which are positioned in the vicinity of this loading station. This means that in the optimal case, p=z in the vicinity of a loading station, where p is the number of loading procedures and z is the number of ingredient containers.

In reality, this ideal case is difficult to implement. Therefore the following applies: p+/−1=z. This is referred to as balanced timing.

Preferably, a cycle time t of approximately two seconds (s) to 5 s and especially three s per loading procedure or pick is provided. This means that with a cycle time of three seconds per loading procedure and a buffer time of five s, this yields p*t+5 s=tₜₒₜ (total time per loading station).

This likewise contributes to achieving a high and stable cycle time when assembling and packaging the ingredients into the ingredient containers since all of the employees along the packaging line perform approximately the same number of loading procedures or picks. This also achieves a stable workload for employees.

This means that the ingredients must be distributed to the loading stations in such a way that the packaging line is efficiently loaded and in particular, balanced timings are achieved.

In the following, rules are presented on which advantageous embodiments of the method according to the invention are based.

1. Preferably, a recipe should not include more ingredients than the loading stations that are provided in the packaging line in order to avoid double loading procedures, which could be incorporated into the process and detected only with great difficulty. A “double loading procedure” is understood to be reaching into an ingredient compartment of a loading station twice within the total cycle time tₜₒₜ.

2. The number of recipes should generally be greater than the number of ingredient compartments per loading station. This is possible because more and more recipes have an intersecting set of shared ingredients.

3. The ingredient compartments of the loading stations are preferably filled in such a way that the loading stations situated at the start of the packaging line or more precisely stated, their ingredient compartments, are loaded with heavier ingredients and the weight of the ingredients in the ingredient compartments decreases along the packaging line in the transport direction. This prevents heavier ingredients such as canned tomatoes from damaging lighter ingredients due to their intrinsic weight.

4. Also preferably, the often-needed and the seldom-needed ingredients are distributed uniformly throughout the loading stations in the packaging line. In this connection, it is also possible for the ingredients that are needed more frequently and the ingredients that have a higher weight to be placed in the ingredient compartments situated toward the bottom in the vertical direction so that an employee has them quickly within reach for loading the corresponding ingredient containers.

5. In a loading station, the number of picks per total cycle can preferably correspond to the number of ingredient containers or more precisely stated, the number of ingredient containers +/−1.

6. An average frequency of the recipes or of the selected recipes (Z1, Z2 . . . Zn) can also be known. Like rules 1 to 5, this contributes to balancing out the ingredient compartments of the loading stations.

7. Furthermore, additional ingredient compartments can be provided in order to position certain ingredients, which are needed more frequently, in a plurality of loading stations in order to increase the portion size.

8. Ingredients of the same type, but different portion size are considered to be different ingredients and are to be respectively placed in separate ingredient compartments.

A method for loading the ingredient compartments in the loading stations can also be inferred from this. This method is controlled by means of the control unit in that the latter automatically detects the loading of the ingredient compartments and issues a corresponding output on an indicator device. The indicator device can comprise one or more screens and/or a printer. Preferably, the indicator device is positioned in the vicinity of or directly on the ingredient compartments so that an operator is shown which ingredient compartment is to be filled with which ingredient. Instead of the issuing the output on an indicator device, it is also possible to activate an automatic transport system that comprises, for example, self-propelled vehicles, which each convey one or more boxes with ingredients from a warehouse and/or a transfer station to the ingredient compartments and the ingredient compartments there are loaded either automatically or manually with the aid of an operator. In the second instance, it is advantageous if the vehicle is provided with an indicator device, which indicates which box is to be loaded into which ingredient compartment.

For example, the loading of the ingredient compartments can be determined according to the following rules:

a) First, the ingredients of the most frequently used recipes are distributed uniformly taking into account the rules listed above. Heavy ingredients are preferably positioned in the first three loading stations. Identical ingredients of different recipes are preferably provided in the same ingredient compartment in the loading station, which makes it possible to minimize the number of required ingredient compartments. The most frequently used recipes preferably comprise no more than 30% of the total number of recipes and preferably no more than 20% of the total number of recipes.

b) The ingredients of the less frequently used recipes are distributed; first, a determination is made as to which ingredients are already assigned to an ingredient compartment. The other ingredients to be distributed are then distributed to other loading stations so that the already assigned ingredients can be used in the assembly of this less frequently used recipe.

c) The loading quantity for all of the ingredient compartments is determined based on the frequency of the respective recipes.

d) Within a loading station, heavy ingredients are preferably positioned in lower ingredient compartments and light ingredients are positioned in higher ingredient compartments. Ingredients that are used more frequently are preferably positioned in the lower ingredient compartments, which are generally located closer to the transport device than the higher ingredient compartments.

In an alternative method, the loading of the ingredient compartments is determined as follows:

a) A determination is made as to the most frequently used ingredients. Then the frequency with which each ingredient is used is assigned to the corresponding recipes.

b) Then the ingredients of the recipes are assigned to the loading stations. This process first begins with the ingredients of the recipe with the highest frequency. Then the ingredients of the recipe with the next lower frequency are assigned. This is repeated as often as necessary until the ingredients of all of the recipes have been assigned. The assignment of the ingredients is carried out according to the above-explained rules, with each ingredient being kept on hand preferably in only a single ingredient compartment. But this cannot always be achieved. In a first step, a customer sends an order for one or more dishes for one or more persons on a supplier's website on the Internet (ordering step). Alternatively, the order can also be sent by email or be placed over the telephone.

A preparation and processing device generates a QR code. The QR code contains recipe data and/or information about the ingredients that are required for the dish or dishes being ordered.

If the ingredient compartments have been loaded, then the individual ingredients can be packed into the ingredient containers. A corresponding method is explained below based on FIG. 1.

In an ordering step, a customer orders a dish, thus generating order data (step S1).

In a reading step, a customer's order data are read, this order data comprising at least recipe data for the ingredients contained in a dish as well as customer data (step S2).

In an assigning step, the ingredient containers are assigned predetermined customer data and are labeled (step S3).

In this case, the ingredient containers 17, for example paper bags, can be dispensed by an automatic dispenser. In addition, adhesive labels with the order data are printed on a printing device and affixed to the ingredient containers. Each label comprises a QR code for the corresponding recipe and an order number. The initially uniform ingredient containers supplied by the automatic dispenser are customized in accordance with the order data. This can also occur on site by means of direct printing on the ingredient containers.

After the assigning step, an inspection step is carried out in which the customer information of the ingredient containers is checked for whether the system has been supplied with the correct ingredient containers in accordance with the order (step S4).

In a conveying step, the ingredient containers are conveyed to a transport device of a packaging line (step S5).

For example, the transport device is a conveyor belt, which is embodied as a linear conveyor, or a roller conveyor. The linear conveyor is embodied as linear or extends in a straight line in the vicinity of the loading stations. Outside of the loading stations, curves and/or branches can be provided. Packaging trays for receiving the ingredient containers can be placed on the conveyor belt. Preferably, boxes are provided for receiving the ingredient containers; such a box has a plurality of compartments for receiving a corresponding number of ingredient containers. For example, the box has two to six or three to five compartments and in particular, five of them;

an individual ingredient container is placed in each compartment. For example, the compartments are labeled with the colors pink, yellow, red, green, and blue. The colored label can be provided in order to show an employee which bag should be placed in which compartment of the box. To accomplish this, first, the barcode on the bag can be scanned. Then, a colored indicator is used to show the employee which bag should be placed in which compartment.

In a positioning step, four or five ingredient containers are positioned in the vicinity of a loading station of the packaging line by means of the transport device; twelve ingredients are kept on hand in the loading station (step S6).

In an indicating step, a corresponding indicator device is used to indicate which of the ingredients in the loading station are included in the recipe data and are to be withdrawn (=picked) from the ingredient compartment (step S7).

In a plurality of loading steps, the ingredient containers are loaded with the respectively indicated ingredient (step S8).

In the next steps, there is a repetition and execution of the positioning step with the ingredient container positioned in another loading station, of the indicating step, and of the loading step, until a predetermined number of ingredients included in the recipe data are present in the ingredient container (step S11).

Preferably, the indicating step can be carried out by means of a corresponding light or color labeling of the respective ingredient compartment, for example by means of a pick by light device.

The loading of the individual ingredient containers can optionally be controlled with a put to light device.

The gripped ingredient can be optically detected with the withdrawal detection device (e.g. a camera).

A loading detection device 20 detects the loading of the ingredient containers with ingredients in the loading stations. For example, the loading detection device 20 is a capacitive proximity sensor.

Through the use of an optical system with multiple cameras and a monitoring device, it is possible to detect the withdrawal of an ingredient from an ingredient compartment, the loading of one of the ingredient containers, and the positioning of one of the ingredient containers along the transport device.

The loading step in a loading station can be verified in an ingredient detection step by means of corresponding sensors such as a photoelectric sensor, a motion sensor, and/or a proximity sensor (step S9). To accomplish this, a withdrawal detection device 10 is preferably provided with motion sensors, which detect whether the correct ingredient and/or the correct ingredient quantity for an ingredient container has been withdrawn from the loading station. The withdrawal detection device in this case is embodied in such a way that a position resolution makes it possible to detect whether an employee has gripped the ingredient from the correct position and/or from the correct compartment. In addition and/or alternatively, with the withdrawal detection device, it is also possible for an employee to use a confirmation means such as a switch or button provided on the ingredient compartment to confirm that the correct ingredient has been withdrawn.

By means of such a withdrawal detection step in the individual loading stations, the cycle time of the current method is adapted in order to prevent ingredient containers that have not yet been completely packed from being removed from a loading station and already conveyed to the next loading station.

The withdrawal detection step also provides direct feedback to a warehouse management system in order to acknowledge the withdrawal, to fill inventories and ingredient compartments of a loading station, and if need be to perform corrections in the event of a shortage.

In a detection step, it is also possible for the ingredient containers to be detected in the individual loading stations (step S10).

The reading step is repeated at least two, three, and preferably four times, or also several times with other order data so that in each of the loading stations of the packaging line, two, three, and preferably four ingredient containers are loaded simultaneously. The reading step can also comprise the simultaneous, synchronous, or also time-delayed reading of a plurality of order data.

The reading step can be triggered by the reading of a corresponding label on an ingredient container that is supplied to the transport devices so that the respective order data relating to the supplied ingredient container are read. On the other hand, the order data can also be stored in the ingredient containers, e.g. by means of an RFID card, and can be read directly from the ingredient containers.

The order data, which comprise at least the recipe data of the ingredients contained in a dish and the customer data, are then forwarded to a control unit of a device 1 according to the invention. This is referred to as the reading step.

In an assigning step, the ingredient containers are assigned predetermined customer data and in a labeling device 2, the ingredient containers are labeled with the customer data. The label with the customer data can, for example, be a barcode (ID number).

Then in a conveying step, the ingredient containers are conveyed to corresponding receiving sections of a transport device 4 of the packaging line 6.

In this case, the conveying step can be performed manually by an employee or also be performed automatically by a corresponding feeder device.

In a scanning or inspection step, an optical monitoring device 22 first scans four ingredient containers in order to confirm to the system that the correct ingredient containers 17 have been conveyed to the transport device according to the present orders.

In a positioning step, the transport device 4 simultaneously positions four ingredient containers in the vicinity of a first loading station 7 of the packaging line 6.

In an indicating step, a put by light device 18 of an indicator device 9 labels the ingredient containers 8 if the ingredients contained in the ingredient compartments of the loading station 7 are to be positioned in one of the ingredient containers 17.

At the same time, in the indicating step, a pick by light device 19 of the indicator device 9 is used to correspondingly illuminate the ingredient compartments 8 of the loading station 7 so that because of the simple light labeling, an employee can quickly and efficiently withdraw the ingredients from the ingredient compartments 8 and supply or load them into the corresponding ingredient containers 17.

After such a loading step of a loading station 7 is completed, an inspection device verifies whether the ingredient containers are still correctly positioned on the transport device 5 or whether for example an ingredient container has fallen off the transport device 4 during the loading.

If all of the employees at all of the loading stations have performed the corresponding loading procedures of the ingredient containers, then the four ingredient containers 17 are conveyed to the next loading station 7 of the packaging line 6 in the transport direction 5 and new ingredient containers are correspondingly supplied to the first loading station 4.

These steps are repeated until the ingredient containers have passed through the whole packaging line 6.

Then the ingredient container is closed by a closing device in a closing step (step S12).

In parallel with this, if proteins such as milk or meat are contained in the dish, then they are assembled in the same way, positioned in a corresponding insulated package.

Then the ingredient container or containers and the protein ingredients are positioned in the transport container and the transport container is also closed (step S13).

Before the closing of the transport container, a final inspection device verifies whether the ingredient container and the protein ingredients match the recipe data and the customer data in order to make sure that the correct ingredient container is positioned in the transport container. In addition, the recipes that are needed to prepare meals are added to the transport container.

Then the transport container can be shipped (step S14).

Technical details and preferred or alternative embodiments of the present invention will be highlighted below.

According to the present exemplary embodiment, a packaging line of this kind has a length of about 28 m, for example.

In this case, for example ten loading stations are provided along the packaging line in the transport direction, in each of which an employee loads the ingredient containers with the corresponding ingredients.

Each loading station in this case is approximately 1.8 m long and comprises ingredient compartments, which are arranged in three rows with four compartments each.

The cycle time per ingredient container is preferably approximately two to three seconds so that all four ingredient containers positioned in a loading station can be loaded after about nine to twelve seconds per loading station. In this way, the present invention makes it possible to prepare approximately 1200 to 1800 completely loaded transport containers per hour.

In particular, if individual ingredients are already assembled to produce a corresponding ingredient, for example when a recipe includes the herbs and vegetables for flavoring a soup, then the parsley, celery, and carrots are already placed in a single ingredient compartment so that they do not have to be separately assembled. The same is true for seasonings that are placed in the ingredient compartments in an already prepackaged form, for example.

In particular, the heavy foods are placed in the ingredient container first, i.e. the heavy foods are positioned in the front packaging lines of the packaging line and the lighter foods are kept on hand in the back region of the packaging line in the transport direction.

This enables a completely individual preparation and assembly of ingredient containers.

Preferably, two separate packaging lines are provided for packaging protein ingredients and the ingredients provided in the ingredient containers. The protein ingredients are packed into corresponding insulated packages.

For example, the two packaging lines can be arranged in mirror image fashion.

The labeling of the ingredient containers and the protein ingredients is carried out automatically and with a corresponding barcode.

The recipes for the dishes contained in the transport container are also placed in it.

In particular, the control unit, which comprises a computer, is provided, which receives the customer's order and controls the packaging line accordingly.

This enables an efficient timing so that a packaging line of this kind is embodied to be 40 to 50% more productive than known packaging lines.

In the context of the present invention, a system and method are also provided for filling and refilling the ingredient compartments of the loading stations. This constitutes a separate concept of the invention, however.

Through the sequential provision of different rare ingredients into one and the same shelf compartment, it is possible to massively increase the number of available SKUs (SKU stands for stock keeping unit, an individual registration number or QR code, etc., which is assigned to a product for identifying and tracking it). It is thus possible to achieve a large-scale, much more flexible variety of products and to significantly increase the number of recipes that can be produced.

In this connection, it is possible, for example, for there to be a railroad delivery depot that is supplied with standardized ingredient units or ingredient containers by a supplier.

In this case, a transport device such as a flexible conveyor belt can be provided in order to supply the ingredients to the corresponding loading stations.

Alternatively, it is also possible to provide a reception of ingredients and a loading of the ingredient containers by means of autonomously navigating robots.

In order to avoid delivery bottlenecks and ensure a sufficient inventory, it is also possible to provide a high-rack warehouse for storing the ingredients.

For example, the ingredients can be positioned in the high-rack warehouse using what is referred to as “chaotic filling.” This high-rack warehouse can then also be automatically refilled as part of what is referred to as a “kitting” process. [I don't understand what kitting is, should a brief description of it be given?]

Dynamic warehousing, also known as chaotic warehousing, is a warehousing method and offers an alternative to the fixed-slot system.

It is a storage principle in which an item to be stored, for example a food, does not have a fixed storage slot, but is instead stored in any slots that are not currently occupied (free-slot system).

The fixed-slot system, in which the items to be stored have a fixed storage slot, and chaotic storage can also be mixed and used in combination, depending on the article or product groups.

The basic advantages compared to the fixed-slot system are as follows:
Better utilization of the storage space since the unoccupied slots are available for all goods to be stored; this—by contrast with the fixed-slot system—results in a better utilization of the capacity of the warehouse and thus optimizes the use of the storage space. In the fixed-slot system—when articles are used—free slots are closed to other articles; the space savings achieved by the free-slot system is considerable.
Trouble-free storage of new items and execution of product line changes since in a fixed-slot system, e.g. the event of storage procedures that have not been planned in advance, it is first necessary, by rearranging, to create new fixed storage slots with free slots or to eliminate old storage slots in order to be able to retain the system and accept these items.
Employees do not need to have warehousing knowledge about fixed storage slots since these are predetermined by the computer-aided storage vouchers. This reduces the familiarization phase for new personnel. Some also consider the fixed-slot system to be more advantageous, though; according to them, the employees who work there quickly become familiar with the storage slots.
For example, if it is no longer possible to remove articles from an aisle of a high-rack warehouse—e.g. due to a breakdown of a rack conveyor—, then there is a high probability of all articles still being available—even though in a reduced quantity. In the fixed-slot system, though, this can quickly result in the complete breakdown in the picking of an article if the nonfunctioning aisle is the sole fixed storage slot for this article.
A rotation and changeover of merchandise can be taken into account in the occupation of space, thus optimizing the travel distances—and thus the times for storage and retrieval from storage—since fast-turnover articles can be stored in free slots close to the warehouse exits.

In order not to lose track of things with the arbitrary instead of fixed assignment of storage slots, it has turned out to be “obligatory” to use a warehouse management system, which maintains a slot allocation list. Basically, the recording of storage slots is only carried out automatically with a computer-aided warehouse management system, which is also responsible for the allocation of each storage slot.

A coordinate system must be defined and used for the storage slots in the warehouse; in order to keep track of everything in the warehouse, numerically possible storage slots are made latent if need be and as a result, they are no longer available as storage slots. Consequently, the symmetry of the classification system is maintained in homogeneous storage zones and the picking is facilitated since in particular, defined shelf sections in each row begin at the same height of the shelf sections of the adjacent shelving units. In this way, it is then possible, for example, to also use cantilevered shelving units in addition to pallet shelving units in a storage zone and the matrix is maintained. In particular, the latency of storage slots can also be used to compensate for bulkiness in the external dimensions of articles, which to a certain extent, is only possible through the use of non-automated storage techniques with a low rotation of merchandise through the use of reconfigurable shelving units and cabinets and by removing and relocating side walls and shelves.

For the stored goods, a labeling system must be defined and used and these goods must be labeled in a preferably (at least (semi-)automatically) readable way.

In order to carry out this warehousing in an optimal way, when using shelving units, it is necessary to keep standardized storage slots available in order, among other things, to ensure a sufficient capacity of all of the shelves for all of the packages.

The same external dimensions of articles and universally reliable item weights in homogeneous storage zones also facilitate the automation of this form of warehousing, which is why it is primarily used in central delivery warehouses with a high turnover rate where its advantages show. It is typical in high-rack warehousing.

In order to avoid media disruptions, an automatic identification of the article at the identification point (I point) is customary, which can be accomplished these days by means of RFID transponders and/or barcodes affixed to the pallets. The verifying detection of the corresponding information about the identity of the stored goods and the actual storage slot can also be performed automatically, for example by the storage and retrieval vehicle or industrial truck. In addition, another commonly used solution in the context of mobile data acquisition is the use of PDAs or WLAN-enabled scanners (barcode reading devices, RFIDs, etc.).

Through mixed concepts or taking other criteria into account, it is possible, despite the use of dynamic warehousing, to carry out a further optimization of the allocation of storage slots. In this case, a part of the inventory is chaotically stored in free slots and for example other parameters are taken into account for optimizing the travel distances for placement into storage and retrieval from storage.

Ideally, the slot selection should be made by compartment sizes that are appropriate to the material and the shortest distance from the warehouse entrance. In particular, it is possible to reduce the average travel distance by using an ABC classification:

Often-needed articles are stored where they can be reached quickly; seldom-needed articles are stored in the back part of the warehouse; heavy articles more toward the bottom, light articles more toward the top.

With automatic refilling, the “pick and drop” involves the problem that a large number of foods and ingredients such as tomatoes or strawberries are pressure-sensitive and as a result, automation is more difficult to achieve. For this reason, pressure-sensitive ingredients must in particular be supplied to the corresponding ingredient compartments of the loading station as a complete unit in standardized containers.

A device 1 for preparing ingredients for at least one dish, which is embodied according to another aspect of the invention, will be described below. Unless otherwise described, this device 1 has the same components with the same properties as the two devices 1 that are described above and shown in FIG. 2. Components that are the same have been provided with the same reference numerals.

When refilling ingredient compartments of the loading stations, it is also possible to use a barcode reading device, which is provided in the vicinity of the loading stations, in order to read a barcode affixed to standardized ingredient units or ingredient containers and to indicate on an indicator device the ingredient compartment to which this ingredient unit or ingredient container is to be supplied.

On the other hand, upon delivery of the ingredient units or ingredient containers, they can be provided with a compartment label, which is for example printed directly onto the ingredient container or ingredient unit or glued to it by means of a sticker, with the corresponding compartment labels being provided on the corresponding ingredient compartments of the loading stations. By means of this, an operator can easily associate the ingredient containers or ingredient units to the correct ingredient compartments and refill the latter.

This device 1 therefore comprises a packaging line 6 or a loading line with a transport device 4 and a plurality of loading stations 7 positioned successively along the transport device 5 in a transport direction 5, with at least two or more ingredients being kept on hand in each loading station 7 (FIG. 3).

According to this aspect, only a pick by light device 18 and an optical monitoring device 22 with cameras 100 are provided for the loading of the ingredient containers, as described in detail below.

The device also comprises a refrigerated loading line 23 with a refrigerated transport device 24 and a plurality of refrigerated loading stations 26 positioned successively along the refrigerated transport device 24 in a refrigerated transport direction 25, with at least two or more refrigerated ingredients being kept on hand in each refrigerated loading station 26.

According to the present aspect, two refrigerated loading stations 26 are each provided with 12 refrigerated ingredient compartments 27; four refrigerated ingredient containers (not shown) can be respectively positioned on the refrigerated transport device 25 in the vicinity of a refrigerated loading station 26 in order to be loaded.

At least two or more refrigerated ingredients are kept on hand in the refrigerated loading station 23. These refrigerated loading stations 27 are situated in a refrigerated room 30 so that the refrigerated loading stations 26 are kept at a temperature between 0° C. and 2° C.

The refrigerated transport device 25 is positioned adjacent to the refrigerated room. In the region of the refrigerated ingredient compartments 27, openings in the refrigerated room 31 are provided so that the ingredients can be taken out of the refrigerated ingredient compartments 27. In the region of these openings, an air curtain and/or a curtain made of strings or belts can be provided in order to minimize the air exchange between the cool air of the refrigerated room and the warmer air of the adjacent space in which the transport device is situated.

The transport device 4 and the refrigerated transport device 25 are brought together to form a single shared transport device 28. In the vicinity of a uniting region 29 in which the transport device 4 is married to the refrigerated transport device 25, the refrigerated ingredient container is positioned in the ingredient container

Refrigerated protein ingredients such as milk or meat are supplied to the ingredient container or preferably the transport package in a separate packaging line, the refrigerated line. In this case, protein ingredients are protected by thermal insulation by means of an insulated package, the refrigerated ingredient container.

The shared transport device 28 has a replacing station 30 in which incorrectly loaded ingredients and/or allergens and/or other ingredients can be replaced or additionally added in accordance with customer orders.

Consequently, one or more employees can be provided who replace and/or add ingredients in the replacing station 30 and/or during the assembly process between the individual loading stations. This is particularly appropriate when it is a quick replacement or quick addition. This is the case, for example, when a customer is given a bag of candy with its 100^{th} order. It is not necessary to establish a separate loading station for the bag of candy; an employee can quickly add the bag “on the fly.” Preferably, the employee responsible for this is informed of the corresponding processes that are ongoing and require special attention. This can be carried out, for example, by means of a tablet or smartphone and an application running on it.

As the shared transport device 28 continues on its journey, the ingredient containers are positioned together with the refrigerated ingredient containers in a shared transport container (not shown).

In addition, a frozen line with a frozen transport device and with a plurality of loading stations positioned successively along the frozen transport device in a transport direction can be provided, with at least two or more ingredients being kept on hand in each loading station and with the frozen line being embodied separately or as a component of the refrigerated line.

The transport device and/or the refrigerated transport device (and/or the frozen transport device) can extend along a linear transport direction or along branched transport directions.

Printed recipe instructions for the dishes contained in the transport container are also provided in it. The printing of the recipe card can be carried out just in time when the corresponding ingredient containers 17 have been loaded completely. For example, it can be begun only when the ingredient container or dish bag with the protein has been placed into the box and/or transport container and/or when an additional scan of the ID number (barcode) of the ingredient container has been performed.

In particular, the computer system or control unit is provided, which receives the customer's order and controls the packaging line accordingly.

The transport device and the refrigerated transport device are brought together to form a single shared transport device.

In particular, multiple packaging lines or production lines according to the invention can be combined with one another, for example in order to package protein ingredients (meat, fish, dairy products, etc.) from a refrigerating unit or another refrigerated packaging line in a separate insulated package (Woolcool or the like with a cooling element), which is then loaded similarly to an ingredient container.

Like the exemplary embodiment explained above, this device 1 has a transport device 4 for conveying ingredients along a packaging line 6 in the transport direction 5 (FIG. 5). The transport device 4 can be a conveyor belt or also a roller conveyor or roller track. On the transport device 4, packaging trays with ingredient containers 17 are conveyed in which one or more ingredient containers 17 are positioned. The ingredient containers can be paper bags, which can be damaged or get caught on protrusions when placed directly onto the transport device 4. This is why the packaging trays are provided, which are rigid, flat trays, so that on the one hand, they can be reliably conveyed on the transport device 4 and on the other hand, the ingredient containers 17 continuously assume the correct position on the transport device 4. Preferably, the trays are refrigerated or provided with a cooling element. In transport devices 4, which are suitable for directly transporting paper bags or paper sacks, the transporting process can naturally also be carried out without packaging trays. The packaging trays can also be referred to as receiving sections.

Loading stations 7 are positioned successively along the transport device and each have several ingredient compartments in which the ingredients are kept on hand. An operator must then withdraw ingredients from the ingredient compartments 8 and place them into an ingredient container 17.

The present exemplary embodiment differs from the preceding exemplary embodiments in that only cameras 100 are used as sensors. These cameras 100 are stationary cameras 100 with a fixed viewing direction. In other words, the cameras 100 do not swivel. The cameras 100 have a lens with a fixed focal length. Several cameras 100 are provided, with overlapping fields of view. The region of each loading station 7 and the adjacent region of the transport device 4 are respectively detected by at least two cameras 100. The cameras 100 are video cameras, which record 50 frames per second, for example.

The region of the ingredient compartments 8 of a loading station 7 and the adjacent region of the transport device 4 are referred to below as a monitoring cell 99. The withdrawal of the ingredients from the ingredient compartments 8 and the placement into the ingredient container 17 take place within such a monitoring cell 99. Each section of the monitoring cell 99 is scanned with at least two cameras 100. The monitoring cell 99 can also be divided into a plurality of subsections, which are scanned with different camera pairs. But this does not mean that each camera 100 scans only a single monitoring cell 99. The cameras can be positioned so that they detect several monitoring cells 99. It is advantageous, though, if their location in the monitoring cells is detected by at least two cameras 100; then the two cameras 100 form a stereo camera that can be used to determine the spatial coordinates of the articles detected by the cameras 100.

Preferably, the cameras 100 are positioned so that at least three cameras 100 together scan a particular scanning region within the monitoring cells 99. This makes it possible to eliminate problems when an object to be scanned is concealed from one of the three cameras 100 by another article. It can then still be detected with the two other cameras 100.

In the present exemplary embodiment, cameras 100/1 are respectively positioned above the transport device 4 and on the side of the operator in the vicinity of the border between adjacent loading stations 7 and fully scan the two adjacent loading stations 7 and their monitoring cells 99 (FIG. 5). Each monitoring cell 99 is thus scanned by two of these operator-side cameras 100/1. Cameras 100/2 are respectively positioned above the ingredient compartments 8 in the middle of the transport device 4 in the transport direction and each detect a particular monitoring cell 99. In the present exemplary embodiment, the ingredient compartments 8 are embodied as shelving units, which is why the cameras 100/2 positioned above the ingredient compartments 8 are referred to as shelf-side cameras.

The cameras are connected via a data network to the control unit, which has a computer. The data network is a bus system via which the image data captured with the cameras 100 are transmitted to the computer.

The computer stores and can run monitoring software 101 that is explained in greater detail below (FIGS. 4 and 6). The software 101 is composed of multiple modules, which exchange data via channels. The channels are logical data connections between the individual modules.

A selection module 102 is provided for receiving the image data generated by the cameras. Each camera is connected to the selection module 102 via an input channel 103. The selection module 102 is used for sorting the incoming image data and for creating new image data streams to other modules.

A separate triggering module 105 is provided for each monitoring cell 99. The triggering module 105 monitors whether a gripping arm of the operator is present in the vicinity of the monitoring cell 99. If this is the case, then a precise monitoring of the monitoring cell 99 by means of a monitoring module 106 is triggered. A monitoring module 106 is provided for each monitoring cell 99. The monitoring is triggered by sending a corresponding triggering signal to the corresponding monitoring module 106 via a triggering channel 114.

The triggering modules 105 are each connected to the selection module 102 via a triggering channel 104 through which the triggering modules 105 each receive an image data stream from the selection module 102. Via the respective status channel 114, the respective triggering module 105 sends its determination E1 as to whether a gripping arm has been detected.

The monitoring modules 106 are used for detecting the gripped ingredients and for detecting the coordinates of ingredients from when they are withdrawn from the ingredient compartment 8 until they are placed into an ingredient container 17.

The monitoring module 106 conveys the coordinates of the ingredients via an evaluation channel 115 to an evaluation module 112, which consolidates and evaluates the different pieces of information.

The monitoring modules 106 are each connected to the selection module 102 via a respective monitoring channel 107.

In addition, an ingredient container monitoring module 108 is provided, which continuously receives image sections from the selection module 102 via an ingredient container monitoring channel 108. It monitors the loading of the individual ingredient containers 17.

The method for packaging ingredients into an ingredient container 17 and the monitoring of this in the above-described packaging line 6 will be explained below (FIG. 7).

The monitoring cell 99 is monitored by cameras 100 throughout the entire packaging process (step S15). The cameras 100 are video cameras and generate images sequences or films at 50 frames per second, for example. The images of the image sequences are analyzed individually. The images of the camera 100 are conveyed to the selection module 102. The selection module 102 continuously conveys a reduced number of images (every 50^{th} in this exemplary embodiment) to the corresponding triggering module 105 via the triggering channels 104. In parallel with this, images are conveyed to the ingredient container monitoring module 108 via the ingredient container monitoring channel 109.

Since each triggering module 105 is embodied to monitor a particular monitoring cell 99, the selection module 102 selects for the respective triggering channel 104 the images of the cameras 100 that scan this entire monitoring cell 99 or at least part of it. Since the cameras 100 generate a multitude of images (e.g. 50 or more frames per second) and several cameras 100 scan a monitoring cell 99 simultaneously, the quantity of image data would be enormous if all of the images showing the respective monitoring cell 99 were to be transmitted to the triggering module 105. In order to reduce the data quantity in the triggering channel 104, the data streams are filtered and only every n^{th} image is transmitted. In the present exemplary embodiment, every 50^{th} image is transmitted. The value “n” is typically at least 10, in particular at least 20, and preferably at least 40.

Through the provision of a plurality of such triggering modules 105, a plurality of monitoring cells 99 can be monitored simultaneously as to whether a gripping event is taking place; the computing power required for this is low because on the one hand, the data quantity of image data is significantly reduced by the selection module 102 and on the other hand, a very simple object recognition method can be used, which merely scans the images for a particular pattern.

If the triggering module 105 detects an arm of an operator, then this triggers the monitoring of the respective monitoring cell 99 by the corresponding monitoring module 106. In FIG. 6, this is symbolized by means of the determination E1. While the monitoring module 106 is active, the monitoring of the respective monitoring cell 99 by the triggering module 105 is deactivated.

The triggering module 105 analyzes the incoming images by means of an automatic object recognition method. Such object recognition methods are known, for example, from “Carsten Steger, Markus Ulrich, Christian Wiedemann: Machine Vision Algorithms and Applications, 2^{nd} edition, Wiley-VCH, Weinheim 2018” or “Bernd Jähne: Digital Image Processing [Digitate Bildverarbetung], 6^{th} edition, Springer-Verlag, Berlin Heidelberg 2005.” This object recognition method of the triggering module 105 is embodied in such a way that it detects a forward-stretching arm of the operator that is extended toward the front. In order to detect the forward-stretching arm, a gripping element marking unit is detected. A gripping element marking unit are elements that have an optical marking. The operators usually wear white work coats. If the images show a white stripe of a predetermined size and orientation, then this can be judged to be an outstretched arm. The coat itself thus constitutes a gripping element marking unit. Such a pattern, which includes only a single wide stripe, can be simply and quickly identified. Alternatively, it is also possible for the arm of the operator to be provided with a particular optical mark, which is very specific. For example, a striped pattern composed of colors that do not otherwise occur in the vicinity of the packaging system 1 can be worn on the sleeve. Then the corresponding image can be searched for at least one such specific color or color combination. If the color section is located within such a pattern, then it is also possible to reliably detest that the operator is extending an arm in the direction toward the ingredient compartment 8. Alternative gripping element marking unit are for example colored and/or specially marked gloves for employees; colored and/or specially marked armbands and/or watches or LEDs or LED arrangements. The gripping element marking units could also be made of an especially reflective material that reflects special light such as UV light particularly well and is detected by the cameras.

At the same time, the ingredient container monitoring module 108 monitors the loading of the individual ingredient containers 17. From the selection module 102 via the ingredient container monitoring channel 109, the ingredient container monitoring module 108 continuously receives image sections at a low frequency, which show the transport device 4 and ingredient containers 17 positioned on it. Since the movement of the ingredient containers 17 occurs in a comparatively slow, linear, and uniform fashion, a reliable determination of the position of the respective ingredient containers 17 can be carried out with a small quantity of image data. Similarly to the monitoring module 106, the ingredient container monitoring module 108 identifies ingredient objects to be monitored and the position of the ingredient containers 17.

According to a modification of the present invention, the monitoring of the ingredient containers 17 can be carried out by providing the ingredient containers 17 with identification markers that can be easily detected by the cameras 100. In comparison to conventional barcodes, these identification markers are large-area, simply structured markings that can be reliably detected, even from a greater distance. On the ingredient containers, they preferably cover an area of at least 2 cm², in particular at least 3 cm or at least 4 cm² and particularly preferably at least 5 cm². They can even be at least 10 cm² in size.

Only a small number of different identification markers are needed; the number of different identification markers should be at least three. But there can also be more than three different identification markers, for example at least five, at least eight, at least ten, at least 20, or at least 30.

The ingredient containers 17 are preferably placed onto the transport device 4 in such a way that the ingredient containers 17 always have the different identification markers in the same chronological order.

For example, three different identification markers are provided, which comprise an A, a B, and a C; the ingredient containers 17 are placed or introduced onto the transport device 4 in such a way that the first ingredient container has the identification marker A, the second ingredient container has the identification marker B, the third ingredient container has the identification marker C, the fourth ingredient container once again has the identification marker A, the fifth ingredient container has the identification marker B, the sixth ingredient container has the identification marker C, the seventh ingredient container once again has the identification marker A, and so on. By maintaining a particular sequence, it is possible to determine, for example, that an ingredient container 17 is missing if it is removed from the transport device 4. It is thus possible in a simple way to monitor that the individual ingredient containers are being correctly transported along the transport device 4 and processed in accordance with the instructions.

In addition, if a transport container travels into the field of view of a camera and the identification marking is detected for the first time, then the respective ingredient container or its identification number can be assigned an ID number for the ingredient container or for a packaging order. This identification number can, for example, be read by means of a barcode reader from a barcode printed on the ingredient container. Such a barcode is not always reliably identifiable by means of the cameras 100, but the significantly larger and simpler identification marking. By means of this, as it is being processed in the vicinity of the packaging line 6, the individual ingredient container 17 can be associated with its ID number at any time through detection of the identification marking by means of one of the cameras 100. This is possible even if a particular identification marking is used several times simultaneously in the vicinity of a packaging line 6 since the sequence of identification markers is known and the corresponding sequence of ID numbers is also known and can therefore be associated.

In this case, it can even be advantageous if the identification numbers on the ingredient containers 17 are not always provided in a predetermined chronological order, but rather in a random chronological order, with the control unit knowing and maintaining the random chronological order.

Preferably, enough different identification markers are present that in all of the ingredient containers 17 that are present in the packaging line 6, the same sequence of identification marking does not occur twice. Since the identification markers can be positioned in arbitrary permutations in individual sequences, it is possible to uniquely mark a large number of ingredient containers 17 in chronological order, even with a small number of identification markers.

The ingredient containers 17 are usually embodied as paper bags, which have two wide side surfaces. Preferably, the same identification marker is provided on both wide side surfaces of one of the ingredient containers 17. This basically makes it possible for the ingredient container 17 to be positioned arbitrarily on the transport device 4. If one of the wide side surfaces is detected by one of the cameras 100, then the ingredient container 17 can be identified and its ID number can be uniquely associated with it.

The identification markers can be letters, numbers, binary numbers, simple barcodes or other markings. For example, they can also be advertising emblems with a different-colored background. If these advertising emblems are embodied with a particular shape, for example circular or rectangular, with an advertising text contained in it, then the different-colored background of the individual advertising emblems can constitute the identification marking. The text is then of no importance. A disinterested observer of the ingredient container 17 in no way recognizes the identification marker as such, instead taking it to be an advertising emblem, which has a different-colored background on the different ingredient containers.

Once the ingredient container 17 has left a predetermined region of the packaging line 6 that is monitored by means of the cameras 100, the assignment of its ID number to the respective identification markers is preferably deleted or eliminated, thus minimizing the number of ID numbers that are assigned to the same identification marking. No later than when the ingredient container 17 is placed in the transport container 20, this assignment can be eliminated or deleted and reassigned to a different ingredient container 17.

With this method, it is thus possible to easily monitor and identify the ingredient containers 17 in the packaging line 6 (FIG. 5); the cameras 100 are able to detect the identification marking from a large distance, for example at least 5 m, in particular at least 10 m, without this requiring expensive cameras or expensive lenses. The trick lies in providing a small number of identification markers, which are provided on the individual ingredient containers 17 in repeating fashion. In this case, they can be provided on the ingredient containers 17 in a particular chronological order. Preferably, however, they are provided on the ingredient containers 17 in a random order so that in a control unit in which the chronological order of the identification marking is maintained, by detecting a plurality of successive ingredient containers based on their sequence of identification markers and comparing them to the entire series of identification markers, it is possible to uniquely identify each individual ingredient container of this detested sequence.

This method can be modified such that no other machine-readable codes are provided on the individual ingredient containers; instead, when the ingredient containers are introduced into the packaging line 6, based on the identification marker, each ingredient container is assigned an ID number that corresponds to an order or a particular recipe. Once the ingredient container is packaged in the transport container, there is no further need to provide or maintain a machine-readable code identifying the recipe or order.

This method can be used not only in a packaging line, but also in all other conveying devices for conveying packaged goods; the packaged goods are conveyed linearly on the conveying device, should be identifiable, and are monitored by means of one or more cameras.

With the above-explained method, it is also possible for the individual stations in which a barcode is scanned by means of a scanner (e.g. at the entrance of the packaging line 6; at the printing device for printing recipes, etc.) to be entirely replaced with the automatic identification by means of identification markers.

The packaging method is explained here by way of example in connection with one loading station 7. The method is carried out in parallel in all of the loading stations 7. It begins with step S16 (FIG. 7). As has been described further above, at this point, images have already been captured and sent by the selection module 102 to the triggering modules 105 or more precisely, to the ingredient container monitoring module 108 (See step S15).

In step S17, the ingredients are present in the ingredient compartment 8. The triggering module 105 does not detect a gripping arm. The determination E1 comes out negative and the monitoring module 106 is not active, i.e. is not receiving any images.

In the next step (step S18), a gripping arm moves into the region of the monitoring cell 99. The determination E1 is therefore affirmative. As a result, the monitoring module 106 is activated or more precisely stated, the monitoring module 106 receives images via the monitoring channel 107. The monitoring module 106 begins the monitoring of the ingredient object.

Alternatively, the activation of the monitoring module 106 (determination E1) can also be carried out through a connection to a pick by light device 18. If the lamp for a particular ingredient is illuminated, then together with the illumination, the monitoring module 106 is activated or more precisely stated, the monitoring module 106 receives images via the monitoring channel 107. In such an embodiment, the triggering modules can be omitted.

The gripping arm monitored by the monitoring module 106 grips the ingredient object (step S19).

From the selection device 102, the monitoring modules 106 receive the image data from the cameras, which each scan the corresponding monitoring cell 99 (three cameras 100 per monitoring cell 99 in the present exemplary embodiment). These image data can also be reduced by filtration and transmission of only every n^{th} image from the respective camera 100. Since the monitoring module 106 is supposed to perform a significantly more precise monitoring of the monitoring cell 99, image data from significantly more images should be transmitted in the monitoring channel 107 than in the triggering channel 104. In this case, “n” is preferably no greater than 20, in particular no greater than 15, 10, or 5 with cameras 100 that generate 50 frames per second. In other words, at least 2.5 frames per second, in particular at least 5 or at least 10 frames per second, are transmitted for each camera. In addition, from the different cameras, which each monitor a cell, images should be transmitted, which have been recorded as synchronously or simultaneously as possible so that the corresponding image pairs are suitable for a stereo image analysis. The image data are preferably transmitted together with time information, which indicates when the individual images were recorded. This time information does not have to bear any relation to absolute time; it is instead sufficient for it to be relative time information, which describes the chronological relationship of individual images to one another.

The use of this filter depends on various parameters. On the one hand, there are cameras 100, which generate image data streams with images at different frequencies. On the other hand, it also depends on the local circumstances of the packaging system 1 and how long it takes between when an ingredient from an ingredient compartment 8 is gripped and when it is set down in an ingredient container 17. It also depends on the subsequent evaluation and what position resolution is required for this.

In step S20, the gripping arm moves the ingredient object to the storage container 17. The monitoring module 106 is active.

The monitoring module 106 is supposed to detect the respective ingredient object that is being gripped. This is carried out with an object recognition method similarly to how this is done with the triggering module 105. Alternative object recognition methods are possible. First, the respective object region in the images in which the object is located is identified and then features of the object are extracted. For example, the identification of the object region can be established based on the detection of the gripping hand. The object region can also contain the gripping hand itself.

For these monitoring modules 106, therefore, only the image sections in which the ingredients are shown are relevant. The selection module 102 can reduce the data quantity by transmitting only sections of the images; the ingredient object must be shown in the section. If the above-explained marking is positioned on the sleeve of the operator at the end adjacent to the hand, then in the selection module 102, this marking can be recognized by means of a simple object recognition method and the section of the image adjacent to this marking or surrounding this marking is cut out and only this section is transmitted to the monitoring module 106 via the respective monitoring channel. This also makes it possible to significantly reduce the data quantity that is to be transmitted from the selection module 102 to the respective monitoring modules 106.

The monitoring module 106 analyzes the images by extracting features of the ingredient object and combining them to form a feature vector, which describes the respective pattern.

These patterns are compared to patterns of ingredient objects stored in a database 110. This comparison determines the similarity of the respective patterns. The item whose pattern has the greatest similarity to the pattern shown in the captured image is recognized as the ingredient object.

The comparison of the detected pattern to the patterns of the ingredient objects stored in the database 110 can be carried out with all ingredient objects. But since there are ingredient objects, which have very similar patterns, for example the ingredient objects of a red apple or a red tomato, it can also be advantageous in the comparison to take into consideration only those ingredient objects that are actually present in the loading station 7. Corresponding information can be accessed and read from a merchandise management system 113. The quantity of ingredient objects to be compared is thus limited from the outset to those ingredients that are actually present in a loading station 7. With the loading of individual loading stations 7, it can also be advantageous to provide ingredients with a similar pattern in different loading stations so as to facilitate the automatic object recognition of the individual ingredients.

In general, the object recognition can be carried out based on syntax, statistics, or structure.

Through the creation of artificial neural networks, comparison to a database is no longer required since the features are stored in the neural network itself. The neural networks may or may not be trained in a monitored fashion. This means that during the learning process, the results of the object recognition are checked and assessed for correctness.

Since multiple images of the gripped ingredient during an individual gripping event are detected in the monitoring module 106, the automatic object recognition can be carried out separately for each image. If different results are obtained for the ingredient object that is to be identified, then the different results can be analyzed. For example, such an analysis can be carried out statistically so that for example the result that is obtained the most frequently is judged to be the correct result. This makes sense particularly if it has a frequency of at least 70%, in particular at least 80%, out of all of the results. On the other hand, the quality of the individual images can be assessed as to how well they reflect the ingredient object. Images in which the ingredient object is concealed or largely concealed can be inherently rejected or assessed as having only a reduced relevance. It is thus possible for the relevance of the individual images and the relevance of the ingredient objects that are identified based on them to be weighted.

The monitoring modules 106 are used not only for recognizing the individual ingredient objects, but also for determining the position of the ingredients during the gripping event.

The position, viewing direction, focal length, and imaging scale of the individual cameras 100 are respectively known. Based on these, when the object is identified in an image, it is possible to determine the direction in which the object is located relative to the camera 100 that has captured the image. These object directions of the individual images are extracted in the monitoring module 106 and are connected to the time at which the image was produced. By combining two object directions that were generated at the same time, it is possible to determine the position of the ingredient object in three-dimensional space. The two cameras 100 that produced the two images from which the object directions have been extracted therefore function like a stereo camera. By taking into account the object direction of the third camera, it is possible to reduce the measured position error.

Consequently, the space-time coordinates 111 of the ingredient objects during the gripping event are detected, which describe the movement of the ingredient object during the gripping event in predetermined steps.

During a gripping event, the monitoring module thus generates the information indicating which ingredient object is being gripped and which movement is being executed with it. This information is forwarded to an evaluation module 112 via an evaluation channel 115.

The space-time coordinates 11 are forwarded to an evaluation module 112, which uses the movement of one of the ingredient objects and the movement coordinates of the ingredient containers 17 to determine which ingredient object is arriving into which ingredient container 17. This is used to monitor the loading of the individual ingredient containers 17.

Among other things, the evaluation module 112 can be used to detect the following actions:
withdrawal of an ingredient from an ingredient compartment 8,
tracking of the movement of the ingredient object from the ingredient compartment 8 into a corresponding ingredient containers 17,
loading of the individual ingredient container 17,
detection of the position of an ingredient container 17 along a transport direction 5.

If the ingredient object has been placed into the storage container, then the method ends with step S21.

This system performs a complete monitoring of the loading of the ingredient containers from when the respective ingredient is gripped in the ingredient compartment to when it is placed in the ingredient container. Any incorrect loading can be detected early on and the corresponding ingredient containers can be separated out and reloaded before they are shipped. The loading of the ingredient containers can also be synchronized with the information from the merchandise management system so that other processes can also be automatically controlled by means of this, for example the reordering of ingredients.

This system does not require any moving parts. The only sensors are cameras 100. The cameras 100 can also be used to read barcodes or other information such as text information on the transport trays, ingredient containers 17, and/or ingredients themselves (e.g. cans). When text information is detected, it is advantageous if this is converted into text data by means of an OCR module.

An advantageous modification lies in the fact that the armbands, watches, sleeves, and/or gloves that trigger the triggering signal of the triggering module 105 have active markers. For example, these could be small LED lamps, which light up in a special color. This facilitates the object recognition and reduces malfunctions due to changing illumination.

It is advantageous that the monitoring module 106 is connected to a merchandise management system (MMS) 113 to generate a model for depicting flows of goods in the business process of the company. The merchandise management system comprises one or more of the following modules:
incoming goods module
outgoing goods module
scheduling and order management module
issuance of scheduling aids and order proposals
generation and monitoring of purchase orders
marketing/management information module.

It can also be advantageous for the last image of the ingredient object before it arrives in the ingredient container to be temporarily stored as a reference image for a certain amount of time, for example a few weeks, in order, in the event of customer complaints, to be able to track which ingredients have actually arrived in the ingredient container 17 and/or the degree of quality with which these ingredients have arrived therein and be able to document this.

It is particularly advantageous to connect the reference images to the employees. The goods may possibly have been damaged only at the customer's premises. Through a correlation of complaints in connection with reference images and the employees, it is possible to check for possibly incorrect handling steps by individual employees. For example, it may be that an employee is grasping the fruit too firmly, which is producing unwanted bruises. Or an employee is tossing sensitive ingredients such as eggs into the ingredient containers 17 as a result of which, they are not arriving in proper shape.

It is particularly advantageous if the devices such as shelving systems, camera systems, or ingredient containers have a particular color, in particular blue. This makes it possible for the devices to be more easily filtered out from the images that are to be analyzed. If the devices largely have the same color, then only the image channels of the complementary colors have to be selected. Images from a camera 100 typically have three color channels: red, green, and blue. For example, if the devices are blue, then the blue portion of the images can be filtered out by only searching the green and red channels. Blue is a particularly suitable device color because organic materials and foods are distinguished by a lack of blue. If the green and red color channels are selected, then this gives organic materials a particularly contrast-rich appearance.

As an alternative to the above-described embodiment, the triggering module 105 can also perform a simple motion detection. To accomplish this, two successive images in an image operation are subtracted from each other. Each image or more specifically, each color channel has one value for each pixel. The values for each pixel in two successive images can be subtracted. If two successive images are the same or at least very similar, then this yields a value of virtually zero for each pixel of the difference image. If the sum of all of the remaining values of all of the pixels after the subtraction lies above a predetermined threshold, then a movement within the image region has taken place since the images differ from each other too excessively. This motion detection is easy to implement and quick to calculate, but cannot distinguish between the movement of a gripping arm and an employee walking by at a distance. For this reason, the cameras could be correspondingly placed so that preferably, no external movement is detected. When detecting a movement, a detection could also be carried out as to whether this movement originates from the gripping arm by checking certain properties of the gripping arm in the image.

In an alternative embodiment, instead of the triggering module 105, all of the images from the camera are transmitted from the selection module to the monitoring module. First, a zero image is captured. There is no visible gripping arm or moving ingredient object in this zero image. The selection module 102, however, performs a subtracting image operation as explained in the paragraph above. In the method, while the gripping arm is placing an ingredient into the ingredient container 17, the zero image is then subtracted from each incoming image. If there is no change or movement in the image, then the sum of all of the pixels lies below a predetermined threshold (see above). If an action or movement occurs, then the image region of the action can be detected since the pixel values are elevated in this region of the difference image. This image region is then cut out from the incoming image and analyzed using an object recognition procedure, as described above for the monitoring module 106. The subtraction significantly reduces both the data quantity of the image data and the computing effort.

Preferably, the object recognition of the monitoring module 106 can also be used for quality assurance. Bad or rotten parts on the ingredient objects such as dented boxes, bruised or dark areas on fruit or vegetables, or moldy spots can be automatically detected with appropriate training and/or database entries. Later, the identified ingredient containers 17 can be manually inspected and the ingredient objects can be appropriately replaced.

An advantageous modification of the invention lies in measuring and analyzing different handling steps. For example, the object recognition can be used to detect how and how long an employee needs to perform a handling step. This time determination can be stored and correlated with other results. It is thus possible, for example, to review a new employee's improvement. In addition, notifications can be generated if an employee's speed and precision decrease over time. The employee can then be prompted to take a break. Furthermore, comparisons could increase employee motivation. It would thus be possible to easily determine an employee of the month. More in-depth correlations could also be measured. For example, the instruction to the employees to “work faster” may lead to an accelerated process flow, but could increase the error rate at the same time. Another example could be in the analysis of seasons. The temperature in the warehouse and the quantity and quality of light could possibly influence the employees' speed and reliability. Such connections can be verified very easily and advantageously by means of the time determination. Corresponding adaptations thus promote not only the employees' wellbeing, but also the speed and quality of processing.

Alternative to the exemplary embodiment described above, another possibility lies in leaving the monitoring module 106 active for a predetermined time after the monitoring module 106 is activated by the triggering module 105. This makes it possible to avoid unwanted pauses in the monitoring module 106 due to an incorrect identification in the triggering module 105.

An advantageous modification of the invention lies in customizing the monitoring cell 99 to an employee. For example, it is likely that left-handed individuals will grip the ingredients differently than right-handed individuals. In addition, the grip position and speed may vary among the individual employees. The more customized the monitoring cell is adjusted to be, the more precise the image recognition will be.

In an alternative embodiment, the monitoring module 106 can also monitor the ingredients in the ingredient compartment. It is thus possible to detect defects and missing ingredients autonomously and/or in tandem with a merchandise management system 113. This deficiency information can be forwarded to corresponding personnel, who fill the ingredient compartments 8.

Another possibility that is an alternative to the above-described exemplary embodiment lies in also using the above-mentioned monitoring by means of cameras 100 in an upstream quality check. It is thus possible to monitor the ingredients, for example, when filling ingredient boxes. The ingredient boxes are subsequently placed onto the shelving units of the packaging line 6 and then constitute the ingredient compartments 8. In the upstream quality check, it is possible among other things to detect the quality, size, and condition and to verify whether the ingredients have been placed into the correct ingredient boxes and whether enough ingredients have been placed in them. Here, too, it is advantageous for there to be a connection to a merchandise management system 113, which can thus automatically calibrate the actual state with the set-point state. This forward placement can take place both in the delivery of the ingredients at the site of the device 1, at an upstream site, or even at the site where the ingredients are produced. It is thus possible, for example, to monitor and record the loading of the ingredient boxes even in the field at a farm or at the packing site of the producer. In particular, sensitive ingredients are picked by hand and placed in corresponding ingredient boxes. This event can be monitored with the present invention. In a quality check in the field, it is thus possible to already monitor the number/quantity of ingredients, their size, their weight, the quality, and their condition. The condition can, for example, describe the degree of ripeness, shape, and/or cleanliness of the ingredient. For example, a potato may be absolutely edible, but be rejected by some customers if there is too much mud or dirt stuck to the potato.

In addition, the above-described monitoring can be used for performing an inventory on a storage system. The system is preferably switched into an inventory mode in this case. Employees then pull out the individual ingredient compartments 8 one after another and the cameras 100 record the ingredient compartment 8. In the monitoring module 106 or in a special inventory module, the image of the ingredient compartment 8 is analyzed and the number of ingredients is calculated. This calculated number can then be compared to the merchandise management system 113. The individual pulling out of the ingredient compartments 8 in this case occurs much faster than manual counting by the employees.

To increase production efficiency, it is possible for a production of the ingredient containers to be controlled through a predetermined selection of recipes according to predetermined rules.

The ingredient containers 17 can be produced in accordance with the logistics company that is performing the shipment. This means that all of the ingredient containers 17 that are to be shipped by a particular logistics company are produced first. Then the ingredient containers 17 that are to be shipped by another logistics company are produced. It is thus possible to minimize the quantity of ingredient containers requiring temporarily storage.

In addition and/or alternatively, the ingredient containers 17 can be produced in accordance with the various shipping regions from which the orders have been received.

It is also possible for production to be carried out in accordance with the production quantity or in accordance with the number of persons for whom the recipe is intended, e.g. families, couples, and singles.

It is also possible to balance out the recipe orders in accordance with the workload. This means that the chronological order of the recipes is determined so that the consumption of ingredients is controlled in such a way that the individual ingredients in the loading stations are refilled at different times. This should result in a balanced production with regard to the consumption of individual ingredients so as to homogenize the refilling of the loading stations.

According to a modification of the device according to the invention, preferably in connection with the optical object recognition, the device has a customization station in a region along the packaging line before the ingredient containers are closed.

At this station, special, already packed ingredients can be replaced with others in order to fulfill customer's special requests. For example, special requests can relate to the replacement of one or more ingredients due to allergies or food intolerances.

For example, one or more employees can be provided to collect the special ingredients in a warehouse and then at the customization station, to add an ingredient and/or replace it with a different ingredient, e.g. based on the customer's special request. For example, the collection can be carried out with the aid of a cart, in particular a cart with a display that is connected to the control unit and on the display, the operator is shown which ingredient is to be picked in the warehouse and which ingredient is to be placed in the ingredient container in the customization station.

It is thus still possible to produce all of the recipes and ingredient containers 17 with similar efficiency and is nevertheless possible to flexibly react to special requests of individual customers. By monitoring the recipes produced, particularly in connection with the optical object recognition, it is easily possible to detect the ingredient containers and recipes and to replace one or more individual ingredients in accordance with customers' requests.

Preferably, the entire device according to the invention can be situated in a refrigerated room.

It could be advantageous to designate a particular region of the device 1 as a restricted area to which only specially trained and/or authorized employees have access. In this restricted area, there can be a packaging line 6 or one or more loading stations 7 of a packaging line 6, which contain valuable ingredients such as caviar, sensitive ingredients such as gold leaf, and/or hazardous ingredients such as dry ice. The restriction to specially trained and/or authorized personnel can reduce workplace accidents, carelessly packaged ingredients, and theft.

### REFERENCE NUMERAL LIST

1 device 26 refrigerated loading station
2 labeling device 27 refrigerated ingredient compartment
3 feeder device 28 shared transport device
4 transport device 29 uniting region
5 transport direction 30 replacing station
6 packaging line 31 refrigerated room
7 loading station
8 ingredient compartments 99 monitoring cell
9 indicator device 100 camera
10 withdrawal detection device 101 monitoring software
11 detection device 102 selection module
12 inspection device 103 input channel
13 closing device 104 triggering channel
14 packaging device 105 triggering module
15 assigning device 106 monitoring module
16 final inspection device 107 monitoring channel
17 ingredient container 108 ingredient container monitoring module
18 pick by light device 109 ingredient container monitoring channel
19 put by light device 110 database
20 loading detection device 111 space-time coordinate
21 position determining device 112 evaluation module
22 optical monitoring device 113 merchandise management system
23 refrigerated loading station 114 status channel
24 refrigerated transport device 115 evaluation channel
25 refrigerated transport direction

FIG. 1:
Ordering step˜S1
Reading step˜S2
Labeling step˜S3 [sic—should be “Assigning step” (Zuordnungsschritt)]
Inspection step˜S4
Conveying step˜S5
Positioning step˜S6
Indicating step˜S7
Loading step˜S8
Ingredient detection step˜S9
Detection step˜S11 [sic—should be “S10”]
Repetition and execution of positioning step, indicating step, and loading step˜S11
Closing step˜S12
Packaging step˜S13
Shipping step˜S14

FIG. 7:
Image capture, image selection, and pattern recognition ˜S15
Start˜S16
Ingredient object in ingredient compartment˜S17
Gripping arm is moving into the region of the monitoring cell˜S18
Gripping arm is gripping the ingredient object˜S19
Gripping arm is moving the ingredient object to the ingredient container˜S20
End˜S21

1. A method for assembling and packaging ingredients for at least one dish comprising:
a reading step, in which a customer's order data are read, this order data comprising at least recipe data for the ingredients contained in a dish as well as customer data,
an assigning step in which at least one ingredient container is assigned predefined customer data,
a conveying step in which the ingredient container is conveyed to a linear conveyor of a packaging line,
a positioning step in which at least one ingredient container is positioned in the region of a loading station of the packaging line by means of the linear conveyor with a predetermined cycle time, these loading stations having at least two ingredients or three, four, or more ingredients kept on hand in corresponding ingredient compartments,
an indicating step in which a corresponding indicator device indicates which of the ingredients in the loading station is included in the recipe data,
a loading step in which the ingredient container is loaded with the corresponding ingredient,
a withdrawal detection step in which a withdrawal detection device uses a sensor to automatically detect a withdrawal of the ingredient from the corresponding ingredient compartment in the loading stations,
the repetition and execution of the positioning step with the ingredient container positioned in another loading station, of the indicating step, and of the loading step until a predetermined number of the ingredients included in the recipe data have been placed in the ingredient container.

2. The method according to claim 1, wherein in additional steps, the ingredient container is closed and in a subsequent step, the ingredient container is packaged in a transport package.

3. The method according to claim 1, wherein the reading step is repeated at least two, three, and preferably four times with other order data so that in the loading stations of the packaging line, two, three, and preferably four ingredient containers are loaded simultaneously.

4. The method according to claim 1, wherein after the assigning step, an inspection step is carried out in which the customer information of the ingredient containers is checked for whether the system has been supplied with the correct ingredient containers.

5. The method according to claim 1, wherein in a loading station, different quantities for a different number of persons, for example two, three, or four persons are kept on hand so that the dish is provided for several persons.

6. The method according to claim 1, wherein five or more loading stations are positioned successively along the packaging line in a transport direction.

7. The method according to claim 1, wherein the ingredient containers in the individual loading stations are detected in a detection step.

8. The method according to claim 1, wherein the loading step in a loading station is checked by means of corresponding sensors in an ingredient detection step.

9. The method according to claim 1, wherein ingredients with a higher weight are positioned in the first loading stations of the packaging line.

10. The method according to claim 1, wherein particular ingredients are assembled into a unit.

11. The method according to claim 1, wherein refrigerated protein ingredients are supplied to the ingredient container in a separate packaging line.

12. The method according to claim 1, wherein in the indicating step, a particular ingredient to be gripped or an ingredient compartment in which this ingredient is positioned is marked with the indicator device.

13. A method for preparing ingredients in a plurality of loading stations of a packaging line, claim 1, wherein multiple loading stations positioned successively along the transport device in a transport direction are provided and at least two or more ingredients are respectively kept on hand in the loading stations, and in the assigning of the ingredients, the frequency of the ordering of recipes that contain the ingredients is taken into account, wherein
the ingredients from a part of the recipes, which have a predetermined high frequency of orders, are first uniformly assigned to the loading stations according to a first sorting feature, and
according to a second sorting feature, these ingredients are assigned to the multiple successively positioned loading stations in descending order in the transport direction according to their weight, and
then the ingredients of the recipes with a lower frequency are assigned to the loading stations according to predetermined sorting features.

14. The method according to claim 13, wherein the same ingredients of different recipes are assigned only once to a single one of the loading stations, provided that this does not conflict with the first or second assigning feature.

15. The method according to claim 13, wherein the part of the recipes that have the predetermined high frequency of orders comprise only the most frequently used 5, 6, 7, 8, 9, 10, or 11 recipes.

16. The method according to claim 13, wherein optically similar ingredients are assigned to different respective loading stations.

17. The method according to claim 13, wherein a control unit is used to control the assignment of the ingredients to the loading stations and the filling of the loading stations with the ingredients.

18. A device for preparing ingredients for at least one dish, comprising a transport device, a plurality of loading stations positioned successively along the transport device in a transport direction, with at least two ingredients and preferably at least four ingredients being kept on hand in a loading station, a position determining device for determining the position of the ingredient container relative to the loading stations, and an indicator device, which marks an ingredient in the loading station that is predetermined by a recipe if the ingredient container is present in the corresponding loading station.

19-42. (canceled)

43. A method for monitoring packaged goods on a transport device, wherein each element of the packaged goods is provided with a particular identification marker, the number of different identification markers is limited, and the chronological order with which the different identification markers are provided on the individual elements of the packaged goods is maintained, comprising:
detection with at least one camera of identification markers of a sequence of successive elements of the packaged goods, and
identification of at least one of the elements—whose identification marker has been detected—based on a comparison of the chronological order of the identification markers of the detected sequence to the maintained chronological order of identification markers.

44-46. (canceled)

47. A method for preparing ingredients in a plurality of loading stations of a packaging line, for a method for assembling and packaging ingredients for at least one dish as claimed in claim 1, wherein multiple loading stations positioned successively along the transport device in a transport direction are provided and at least two or more ingredients are respectively kept on hand in the loading stations, and in the assigning of the ingredients, the frequency of the ordering of recipes that contain the ingredients is taken into account, wherein
the ingredients from a part of the recipes, which have a predetermined high frequency of orders, are first uniformly assigned to the loading stations according to a first sorting feature, and
according to a second sorting feature, these ingredients are assigned to the multiple successively positioned loading stations in descending order in the transport direction according to their weight, and
then the ingredients of the recipes with a lower frequency are assigned to the loading stations according to predetermined sorting features.
